(19) United States
(12) Patent Application Publication
(10) Pub. No.: US 2026/0095905 A1
(43) Pub. Date: Apr. 2, 2026

(54) TECHNIQUES FOR MULTI-CELL SCHEDULING WITH DIFFERENT SUBCARRIER SPACINGS OR CARRIER TYPES

(71) Applicant: QUALCOMM Incorporated, San Diego, CA (US)

(72) Inventors: Kazuki TAKEDA, Minato-ku (JP); Kianoush HOSSEINI, San Diego, CA (US)

(21) Appl. No.: 19/328,963

(22) Filed: Sep. 15, 2025

Related U.S. Application Data
(60) Provisional application No. 63/702,089, filed on Oct. 1, 2024.

(51) Int. Cl. H04W 72/12; H04W 72/232

(52) U.S. Cl. CPC H04W 72/12; H04W 72/232

(57) ABSTRACT

Methods, systems, and devices for wireless communications are described. A user equipment (UE) may receive a downlink control information (DCI) message that schedules at least a first shared channel communication via a first cell and a second shared channel communication via a second cell, the first cell associated with a first subcarrier spacing (SCS), a first carrier type, or both, and the second cell associated with a second SCS, a second carrier type, or both. The DCI message may include multiple sub-fields associated with a cell parameter based on the DCI message scheduling multiple shared channel communications on multiple cells associated with multiple SCSs and/or multiple carrier types, where the first and second sub-fields indicate a first parameter value and a second parameter value, respectively, for the cell parameter that are to be applied for the first cell and the second cell, respectively.

### CROSS REFERENCES

The present application for patent claims benefit of U.S. Provisional Patent Application No. 63/702,089 by TAKEDA et al., entitled “TECHNIQUES FOR MULTI-CELL SCHEDULING WITH DIFFERENT SUBCARRIER SPACINGS OR CARRIER TYPES,” filed Oct. 1, 2024, assigned to the assignee hereof, and expressly incorporated herein.

### INTRODUCTION

The following relates to wireless communications, including techniques for multi-cell scheduling.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a UE is described. The method may include receiving a downlink control information (DCI) message that schedules at least a first shared channel communication via a first cell and a second shared channel communication via a second cell, the first cell associated with a first subcarrier spacing (SCS), a first carrier type, or both, and the second cell associated with a second SCS, a second carrier type, or both, the DCI message including a first subset of bits (e.g., first sub-field) and a second subset of bits (e.g., second sub-field) associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied for the second cell, communicating the first shared channel communication via the first cell in accordance with the first parameter value for the cell parameter, and communicating the second shared channel communication via the second cell in accordance with the second parameter value for the cell parameter.

An apparatus for wireless communication at a UE is described. The apparatus may include one or more memories, and one or more processors coupled with the one or more memories and configured to cause the UE to receive a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits (e.g., first sub-field) and a second subset of bits (e.g., second sub-field) associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied for the second cell, communicate the first shared channel communication via the first cell in accordance with the first parameter value for the cell parameter, and communicate the second shared channel communication via the second cell in accordance with the second parameter value for the cell parameter.

Another UE is described. The UE may include means for receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits (e.g., first sub-field) and a second subset of bits (e.g., second sub-field) associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied for the second cell, means for communicating the first shared channel communication via the first cell in accordance with the first parameter value for the cell parameter, and means for communicating the second shared channel communication via the second cell in accordance with the second parameter value for the cell parameter.

A non-transitory computer-readable medium storing code is described. The code may include instructions executable by one or more processors to receive a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits (e.g., first sub-field) and a second subset of bits (e.g., second sub-field) associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied for the second cell, communicate the first shared channel communication via the first cell in accordance with the first parameter value for the cell parameter, and communicate the second shared channel communication via the second cell in accordance with the second parameter value for the cell parameter.

In some examples of the method, UEs, and non-transitory computer-readable medium described herein, the DCI message further schedules a third shared channel communication via a third cell associated with a third SCS, a third carrier type, or both and the DCI message further includes a third subset of bits (e.g., third sub-field) that indicates a third parameter value for the cell parameter that may be applied for the third cell.

In some examples of the method, UEs, and non-transitory computer-readable medium described herein, the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells including at least the first cell and the second cell, respectively, the first subset of bits may be applied to the first set of scheduled cells based on the first set of scheduled cells being associated with the first SCS, the first carrier type, or both, and the second subset of bits may be applied to the second set of scheduled cells based on the second set of scheduled cells being associated with the second SCS, the second carrier type, or both.

In some examples of the method, UEs, and non-transitory computer-readable medium described herein, the DCI message further schedules a third shared channel communication via a third cell associated with the first SCS, the first carrier type, or both and the first subset of bits may be applied to the first cell and the third cell based on the first cell and the third cell being associated with the first SCS, the first carrier type, or both.

Some examples of the method, UEs, and non-transitory computer-readable medium described herein may further include operations, features, means, or instructions for receiving an indication to switch an SCS for the third cell from the first SCS to the second SCS, where the second subset of bits may be applied to the second cell and the third cell based on the indication and based on the second cell and the third cell being associated with the second SCS.

In some examples of the method, UEs, and non-transitory computer-readable medium described herein, the indication to switch the SCS for the third cell includes a bandwidth part (BWP) switch associated with the third cell.

In some examples of the method, UEs, and non-transitory computer-readable medium described herein, the DCI message schedules a set of multiple shared channel communications for a set of multiple scheduled cells, the set of multiple scheduled cells including at least the first cell and the second cell and a quantity of subsets of bits (e.g., quantity of sub-fields) for the cell parameter included within the DCI message may be based on a quantity of unique SCSs, a quantity of unique carrier types, or both, associated with the set of multiple scheduled cells.

In some examples of the method, UEs, and non-transitory computer-readable medium described herein, the first subset of bits and the second subset of bits may be applied to the first cell and the second cell, respectively, based on the first cell and the second cell being associated with the first SCS and the second SCS, respectively.

Some examples of the method, UEs, and non-transitory computer-readable medium described herein may further include operations, features, means, or instructions for receiving radio resource control (RRC) signaling indicating the first SCS and the second SCS associated with the first cell and the second cell, respectively, where communication of the first shared channel communication, the second shared channel communication, or both, may be based on reception of the RRC signaling.

In some examples of the method, UEs, and non-transitory computer-readable medium described herein, the first subset of bits may be applied to the first cell and the second subset of bits may be applied to the second cell based on the first cell being associated with the first carrier type and the second cell being associated with the second carrier type.

In some examples of the method, UEs, and non-transitory computer-readable medium described herein, the first cell and the second cell may be associated with a first cell identifier (ID) and a second cell ID, respectively and the first subset of bits and the second subset of bits may be applied for the first cell and the second cell, respectively, based on a comparison between the first cell ID and the second cell ID.

In some examples of the method, UEs, and non-transitory computer-readable medium described herein, the first subset of bits and the second subset of bits include sub-fields of a Type 1A field of the DCI message.

In some examples of the method, UEs, and non-transitory computer-readable medium described herein, the DCI message includes a DCI format 0_3 or a DCI format 1_3.

In some examples of the method, UEs, and non-transitory computer-readable medium described herein, the cell parameter includes a BWP indicator, a frequency hopping flag, a demodulation reference signal sequence (DMRS) initialization, a priority indicator, an offset, a channel access parameter, or any combination thereof.

A method by a network entity is described. The method may include outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits (e.g., first sub-field) and a second subset of bits (e.g., second sub-field) associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied to the second cell, communicating the first shared channel communication via the first cell in accordance with the first parameter value for the cell parameter, and communicating the second shared channel communication via the second cell in accordance with the second parameter value for the cell parameter.

An apparatus for wireless communication at a network entity is described. The apparatus may include one or more memories, and one or more processors coupled with the one or more memories and configured to cause the network entity to output a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits (e.g., first sub-field) and a second subset of bits (e.g., second sub-field) associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied to the second cell, communicate the first shared channel communication via the first cell in accordance with the first parameter value for the cell parameter, and communicate the second shared channel communication via the second cell in accordance with the second parameter value for the cell parameter.

Another network entity is described. The network entity may include means for outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits (e.g., first sub-field) and a second subset of bits (e.g., second sub-field) associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied to the second cell, means for communicating the first shared channel communication via the first cell in accordance with the first parameter value for the cell parameter, and means for communicating the second shared channel communication via the second cell in accordance with the second parameter value for the cell parameter.

A non-transitory computer-readable medium storing code is described. The code may include instructions executable by one or more processors to output a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits (e.g., first sub-field) and a second subset of bits (e.g., second sub-field) associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied to the second cell, communicate the first shared channel communication via the first cell in accordance with the first parameter value for the cell parameter, and communicate the second shared channel communication via the second cell in accordance with the second parameter value for the cell parameter.

In some examples of the method, network entities, and non-transitory computer-readable medium described herein, the DCI message further schedules a third shared channel communication via a third cell associated with a third SCS, a third carrier type, or both and the DCI message further includes a third subset of bits (e.g., third sub-field) that indicates a third parameter value for the cell parameter that may be applied for the third cell.

In some examples of the method, network entities, and non-transitory computer-readable medium described herein, the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells including at least the first cell and the second cell, respectively, the first subset of bits may be applied to the first set of scheduled cells based on the first set of scheduled cells being associated with the first SCS, the first carrier type, or both, and the second subset of bits may be applied to the second set of scheduled cells based on the second set of scheduled cells being associated with the second SCS, the second carrier type, or both.

In some examples of the method, network entities, and non-transitory computer-readable medium described herein, the DCI message further schedules a third shared channel communication via a third cell associated with the first SCS, the first carrier type, or both and the first subset of bits may be applied to the first cell and the third cell based on the first cell and the third cell being associated with the first SCS, the first carrier type, or both.

Some examples of the method, network entities, and non-transitory computer-readable medium described herein may further include operations, features, means, or instructions for outputting an indication to switch an SCS for the third cell from the first SCS to the second SCS, where the second subset of bits may be applied to the second cell and the third cell based on the indication and based on the second cell and the third cell being associated with the second SCS.

In some examples of the method, network entities, and non-transitory computer-readable medium described herein, the indication to switch the SCS for the third cell includes a BWP switch associated with the third cell.

In some examples of the method, network entities, and non-transitory computer-readable medium described herein, the DCI message schedules a set of multiple shared channel communications for a set of multiple scheduled cells, the set of multiple scheduled cells including at least the first cell and the second cell and a quantity of subsets of bits (e.g., quantity of sub-fields) for the cell parameter included within the DCI message may be based on a quantity of unique SCSs, a quantity of unique carrier types, or both, associated with the set of multiple scheduled cells.

In some examples of the method, network entities, and non-transitory computer-readable medium described herein, the first subset of bits and the second subset of bits may be applied to the first cell and the second cell, respectively, based on the first cell and the second cell being associated with the first SCS and the second SCS, respectively.

Some examples of the method, network entities, and non-transitory computer-readable medium described herein may further include operations, features, means, or instructions for outputting RRC signaling indicating the first SCS and the second SCS associated with the first cell and the second cell, respectively, where communication of the first shared channel communication, the second shared channel communication, or both, may be based on output of the RRC signaling.

In some examples of the method, network entities, and non-transitory computer-readable medium described herein, the first subset of bits may be applied to the first cell and the second subset of bits may be applied to the second cell based on the first cell being associated with the first carrier type and the second cell being associated with the second carrier type.

In some examples of the method, network entities, and non-transitory computer-readable medium described herein, the first cell and the second cell may be associated with a first cell ID and a second cell ID, respectively and the first subset of bits and the second subset of bits may be applied for the first cell and the second cell, respectively, based on a comparison between the first cell ID and the second cell ID.

In some examples of the method, network entities, and non-transitory computer-readable medium described herein, the first subset of bits and the second subset of bits include sub-fields of a Type 1A field of the DCI message.

In some examples of the method, network entities, and non-transitory computer-readable medium described herein, the DCI message includes a DCI format 0_3 or a DCI format 1_3.

In some examples of the method, network entities, and non-transitory computer-readable medium described herein, the cell parameter includes a BWP indicator, a frequency hopping flag, a DMRS initialization, a priority indicator, an offset, a channel access parameter, or any combination thereof.

A method by a UE is described. The method may include receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell, communicating the first shared channel communication via the first cell in accordance with the first parameter value for the cell parameter, and communicating the second shared channel communication via the second cell in accordance with the second parameter value for the cell parameter.

An apparatus for wireless communication at a UE is described. The apparatus may include one or more memories, and one or more processors coupled with the one or more memories and configured to cause the UE to receive a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell, communicate the first shared channel communication via the first cell in accordance with the first parameter value for the cell parameter, and communicate the second shared channel communication via the second cell in accordance with the second parameter value for the cell parameter.

Another UE is described. The UE may include means for receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell, means for communicating the first shared channel communication via the first cell in accordance with the first parameter value for the cell parameter, and means for communicating the second shared channel communication via the second cell in accordance with the second parameter value for the cell parameter.

A non-transitory computer-readable medium storing code is described. The code may include instructions executable by one or more processors to receive a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell, communicate the first shared channel communication via the first cell in accordance with the first parameter value for the cell parameter, and communicate the second shared channel communication via the second cell in accordance with the second parameter value for the cell parameter.

In some examples of the method, UEs, and non-transitory computer-readable medium described herein, the DCI message further schedules a third shared channel communication via a third cell associated with a third SCS, a third carrier type, or both and the DCI message further includes a third sub-field that indicates a third parameter value for the cell parameter that may be applied for the third cell.

In some examples of the method, UEs, and non-transitory computer-readable medium described herein, the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells including at least the first cell and the second cell, respectively, the first sub-field may be applied to the first set of scheduled cells based on the first set of scheduled cells being associated with the first SCS, the first carrier type, or both, and the second sub-field may be applied to the second set of scheduled cells based on the second set of scheduled cells being associated with the second SCS, the second carrier type, or both.

In some examples of the method, UEs, and non-transitory computer-readable medium described herein, the DCI message further schedules a third shared channel communication via a third cell associated with the first SCS, the first carrier type, or both and the first sub-field may be applied to the first cell and the third cell based on the first cell and the third cell being associated with the first SCS, the first carrier type, or both.

Some examples of the method, UEs, and non-transitory computer-readable medium described herein may further include operations, features, means, or instructions for receiving an indication to switch an SCS for the third cell from the first SCS to the second SCS, where the second sub-field may be applied to the second cell and the third cell based on the indication and based on the second cell and the third cell being associated with the second SCS.

In some examples of the method, UEs, and non-transitory computer-readable medium described herein, the indication to switch the SCS for the third cell includes a bandwidth part (BWP) switch associated with the third cell.

In some examples of the method, UEs, and non-transitory computer-readable medium described herein, the DCI message schedules a set of multiple shared channel communications for a set of multiple scheduled cells, the set of multiple scheduled cells including at least the first cell and the second cell and a quantity of sub-fields for the cell parameter included within the DCI message may be based on a quantity of unique SCSs, a quantity of unique carrier types, or both, associated with the set of multiple scheduled cells.

In some examples of the method, UEs, and non-transitory computer-readable medium described herein, the first sub-field and the second sub-field may be applied to the first cell and the second cell, respectively, based on the first cell and the second cell being associated with the first SCS and the second SCS, respectively.

Some examples of the method, UEs, and non-transitory computer-readable medium described herein may further include operations, features, means, or instructions for receiving RRC signaling indicating the first SCS and the second SCS associated with the first cell and the second cell, respectively, where communication of the first shared channel communication, the second shared channel communication, or both, may be based on reception of the RRC signaling.

In some examples of the method, UEs, and non-transitory computer-readable medium described herein, the first sub-field may be applied to the first cell and the second sub-field may be applied to the second cell based on the first cell being associated with the first carrier type and the second cell being associated with the second carrier type.

In some examples of the method, UEs, and non-transitory computer-readable medium described herein, the first cell and the second cell may be associated with a first cell ID and a second cell ID, respectively and the first sub-field and the second sub-field may be applied for the first cell and the second cell, respectively, based on a comparison between the first cell ID and the second cell ID.

In some examples of the method, UEs, and non-transitory computer-readable medium described herein, the first sub-field and the second sub-field include sub-fields of a Type 1A field of the DCI message.

In some examples of the method, UEs, and non-transitory computer-readable medium described herein, the DCI message includes a DCI format 0_3 or a DCI format 1_3.

In some examples of the method, UEs, and non-transitory computer-readable medium described herein, the cell parameter includes a BWP indicator, a frequency hopping flag, a DMRS initialization, a priority indicator, an offset, a channel access parameter, or any combination thereof.

A method by a network entity is described. The method may include outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell, communicating the first shared channel communication via the first cell in accordance with the first parameter value for the cell parameter, and communicating the second shared channel communication via the second cell in accordance with the second parameter value for the cell parameter.

An apparatus for wireless communication at a network entity is described. The apparatus may include one or more memories, and one or more processors coupled with the one or more memories and configured to cause the network entity to output a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell, communicate the first shared channel communication via the first cell in accordance with the first parameter value for the cell parameter, and communicate the second shared channel communication via the second cell in accordance with the second parameter value for the cell parameter.

Another network entity is described. The network entity may include means for outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell, means for communicating the first shared channel communication via the first cell in accordance with the first parameter value for the cell parameter, and means for communicating the second shared channel communication via the second cell in accordance with the second parameter value for the cell parameter.

A non-transitory computer-readable medium storing code is described. The code may include instructions executable by one or more processors to output a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell, communicate the first shared channel communication via the first cell in accordance with the first parameter value for the cell parameter, and communicate the second shared channel communication via the second cell in accordance with the second parameter value for the cell parameter.

In some examples of the method, network entities, and non-transitory computer-readable medium described herein, the DCI message further schedules a third shared channel communication via a third cell associated with a third SCS, a third carrier type, or both and the DCI message further includes a third sub-field that indicates a third parameter value for the cell parameter that may be applied for the third cell.

In some examples of the method, network entities, and non-transitory computer-readable medium described herein, the DCI message schedules a first set of shared channel communications via a first set of scheduled cells associated with the first

SCS, the first carrier type, or both, and a second set of shared channel communications via a second set of scheduled cells associated with the second SCS, the second carrier type, or both, the first set of scheduled cells and the second set of scheduled cells including at least the first cell and the second cell, respectively, the first sub-field may be applied to the first set of scheduled cells based on the first set of scheduled cells being associated with the first SCS, the first carrier type, or both, and the second sub-field may be applied to the second set of scheduled cells based on the second set of scheduled cells being associated with the second SCS, the second carrier type, or both.

In some examples of the method, network entities, and non-transitory computer-readable medium described herein, the DCI message further schedules a third shared channel communication via a third cell associated with the first SCS, the first carrier type, or both and the first sub-field may be applied to the first cell and the third cell based on the first cell and the third cell being associated with the first SCS, the first carrier type, or both.

Some examples of the method, network entities, and non-transitory computer-readable medium described herein may further include operations, features, means, or instructions for outputting an indication to switch an SCS for the third cell from the first SCS to the second SCS, where the second sub-field may be applied to the second cell and the third cell based on the indication and based on the second cell and the third cell being associated with the second SCS.

In some examples of the method, network entities, and non-transitory computer-readable medium described herein, the indication to switch the SCS for the third cell includes a BWP switch associated with the third cell.

In some examples of the method, network entities, and non-transitory computer-readable medium described herein, the DCI message schedules a set of multiple shared channel communications for a set of multiple scheduled cells, the set of multiple scheduled cells including at least the first cell and the second cell and a quantity of sub-fields for the cell parameter included within the DCI message may be based on a quantity of unique SCSs, a quantity of unique carrier types, or both, associated with the set of multiple scheduled cells.

In some examples of the method, network entities, and non-transitory computer-readable medium described herein, the first sub-field and the second sub-field may be applied to the first cell and the second cell, respectively, based on the first cell and the second cell being associated with the first SCS and the second SCS, respectively.

Some examples of the method, network entities, and non-transitory computer-readable medium described herein may further include operations, features, means, or instructions for outputting RRC signaling indicating the first SCS and the second SCS associated with the first cell and the second cell, respectively, where communication of the first shared channel communication, the second shared channel communication, or both, may be based on output of the RRC signaling.

In some examples of the method, network entities, and non-transitory computer-readable medium described herein, the first sub-field may be applied to the first cell and the second sub-field may be applied to the second cell based on the first cell being associated with the first carrier type and the second cell being associated with the second carrier type.

In some examples of the method, network entities, and non-transitory computer-readable medium described herein, the first cell and the second cell may be associated with a first cell ID and a second cell ID, respectively and the first sub-field and the second sub-field may be applied for the first cell and the second cell, respectively, based on a comparison between the first cell ID and the second cell ID.

In some examples of the method, network entities, and non-transitory computer-readable medium described herein, the first sub-field and the second sub-field include sub-fields of a Type 1A field of the DCI message.

In some examples of the method, network entities, and non-transitory computer-readable medium described herein, the DCI message includes a DCI format 0_3 or a DCI format 1_3.

In some examples of the method, network entities, and non-transitory computer-readable medium described herein, the cell parameter includes a BWP indicator, a frequency hopping flag, a DMRS initialization, a priority indicator, an offset, a channel access parameter, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for multi-cell scheduling with different SCSs or carrier types in accordance with one or more aspects of the present disclosure.

FIG. 2 shows an example of a network architecture that supports techniques for multi-cell scheduling with different SCSs or carrier types in accordance with one or more aspects of the present disclosure.

FIG. 3 shows an example of a scheduling configuration that supports techniques for multi-cell scheduling with different SCSs or carrier types in accordance with one or more aspects of the present disclosure.

FIG. 4 shows an example of a wireless communications system that supports techniques for multi-cell scheduling with different SCSs or carrier types in accordance with one or more aspects of the present disclosure.

FIG. 5 shows an example of a DCI message format that supports techniques for multi-cell scheduling with different SCSs or carrier types in accordance with one or more aspects of the present disclosure.

FIG. 6 shows an example of a DCI format that supports techniques for multi-cell scheduling with different SCSs or carrier types in accordance with one or more aspects of the present disclosure.

FIG. 7 shows an example of a process flow that supports techniques for multi-cell scheduling with different SCSs or carrier types in accordance with one or more aspects of the present disclosure.

FIGS. 8 and 9 show block diagrams of devices that support techniques for multi-cell scheduling with different SCSs or carrier types in accordance with one or more aspects of the present disclosure.

FIG. 10 shows a block diagram of a communications manager that supports techniques for multi-cell scheduling with different SCSs or carrier types in accordance with one or more aspects of the present disclosure.

FIG. 11 shows a diagram of a system including a device that supports techniques for multi-cell scheduling with different SCSs or carrier types in accordance with one or more aspects of the present disclosure.

FIGS. 12 and 13 show block diagrams of devices that support techniques for multi-cell scheduling with different SCSs or carrier types in accordance with one or more aspects of the present disclosure.

FIG. 14 shows a block diagram of a communications manager that supports techniques for multi-cell scheduling with different SCSs or carrier types in accordance with one or more aspects of the present disclosure.

FIG. 15 shows a diagram of a system including a device that supports techniques for multi-cell scheduling with different SCSs or carrier types in accordance with one or more aspects of the present disclosure.

FIGS. 16 through 19 show flowcharts illustrating methods that support techniques for multi-cell scheduling with different SCSs or carrier types in accordance with one or more aspects of the present disclosure.

### DETAILED DESCRIPTION

Some wireless communications systems may support multi-carrier or multi-cell operation to increase data rates and decrease latency. Some wireless communications systems may implement cross-cell or multi-cell scheduling. In cross-cell scheduling, a UE may receive a DCI message via a “scheduling cell” that schedules communication(s) on a different “scheduled cell.” Similarly, in multi-cell scheduling, the UE may receive a DCI message via the scheduling cell that schedules communications on multiple different scheduled cells. For example, DCI formats 0_3 or 1_3 may be used to schedule up to four cells, and DCI formats 0_3 or 1_3 may schedule up to eight physical uplink shared channel (PUSCH) or physical downlink shared channel (PDSCH) transmissions.

Scheduling multiple shared channel communications via a single DCI may save UE power (e.g., by reducing the quantity of physical downlink control channel (PDCCH) occasions for the UE to monitor) and may reduce PDCCH overhead by reducing the quantity of DCI messages that are used to schedule communications (e.g., by preventing the network from using separate DCI messages to schedule separate communications). However, some wireless communications may not allow for multi-cell scheduling when the scheduled cells are associated with different SCSs and/or carrier types. That is, scheduled cells with different SCSs or carrier types may exhibit different cell parameters or characteristics, and DCI formats may not provide the flexibility to indicate the respective cell parameters for the different cells with different SCSs/carrier types. In such cases, the network may use separate DCI messages to schedule the communications on the cells that exhibit different SCSs and/or different carrier types. In other words, some wireless networks do not allow for a single DCI message to schedule communications across multiple scheduled cells with different SCSs or carrier types.

Accordingly, aspects of the present disclosure relate to new structures for DCI formats (e.g., DCI formats 0_3 or 1_3) that enable multi-cell scheduling across scheduled cells with different SCSs and/or different carrier types. In particular, aspects of the present disclosure are directed to modifications to a DCI format(s) to include different sub-fields (e.g., sub-fields of a Type 1A field) that indicate common cell parameters for scheduled cells with different SCSs and/or carrier types. For instance, some aspects of the present disclosure propose modifications to a DCI format 0_3, DCI format 1_3, or both, to include sub-fields that facilitate the respective DCI format(s) to perform multi-cell scheduling across scheduled cells with different SCSs and/or different carrier types. For the purposes of the present disclosure, the term “sub-field” may be used to refer to a portion or subset of a DCI message or field, and may therefore be used to refer to a subset of bits, a “block” of a DCI field, a “sub-block” of a DCI field, or any combination thereof. In this regard, for the purposes of the present disclosure, the terms “sub-field,” “subset of bits,” “block,” “sub-block,” and like terms, may be used interchangeably to refer to a portion or a subset of a DCI message.

According to aspects of the present disclosure, a DCI used for multi-cell scheduling across different scheduled cells may include multiple sub-fields (e.g., multiple subsets of bits) that are used to indicate parameters/characteristics of the respective scheduled cells with different SCSs and/or carrier types. For example, a UE may receive a DCI message that schedules communications (e.g., PDSCH, PUSCH) on a first set of cells associated with a first SCS and/or first carrier type and a second set of cells associated with a second SCS and/or carrier type. In this example, the DCI message may include two different sub-fields of a DCI field (such as sub-fields of a Type 1A DCI field) that indicate cell parameter values for two respective sets of cells with different SCSs/carrier types. For instance, a first sub-field may indicate a bandwidth part (BWP) indicator for the first set of cells associated with the first SCS, and a second sub-field may indicate a BWP indicator for the second set of cells associated with the second SCS. While much of the present disclosure is descried in the context of DCI messages indicating parameters for scheduled cells with different SCSs and/or different carrier types, aspects of the present disclosure may also be used to indicate parameters for scheduled cells that have the same SCS and/or same carrier type, but differ in some other characteristic or parameter. In this regard, referring to the example above, in some cases, the first SCS and the second SCS (and the first carrier type and the second carrier type) may be different or the same.

Aspects of the present disclosure may facilitate improved multi-cell scheduling. In particular, aspects of the present disclosure may enable a DCI message to indicate cell parameters for multiple scheduled cells with different SCSs and/or carrier types, thereby reducing the quantity of control signaling exchanged within the network (e.g., by preventing the network from having to send different DCI messages to schedule communications on scheduled cells with different SCSs/carrier types, or another parameter(s) that is different across the scheduled cells). As such, aspects of the present disclosure may reduce control signaling overhead, which may lead to less wireless traffic, fewer collisions between wireless communications, and improved reliability within the wireless network. Further, by reducing the amount of control signaling used to schedule communications at the UE, aspects of the present disclosure may reduce the power consumption at the UE, thereby improving battery life.

Aspects of the disclosure are initially described in the context of wireless communications systems. Additional aspects of the disclosure are described in the context of example DCI formats and an example process flow. Aspects of the disclosure are further illustrated by and described with reference to apparatus diagrams, system diagrams, and flowcharts that relate to techniques for multi-cell scheduling with different SCSs or carrier types.

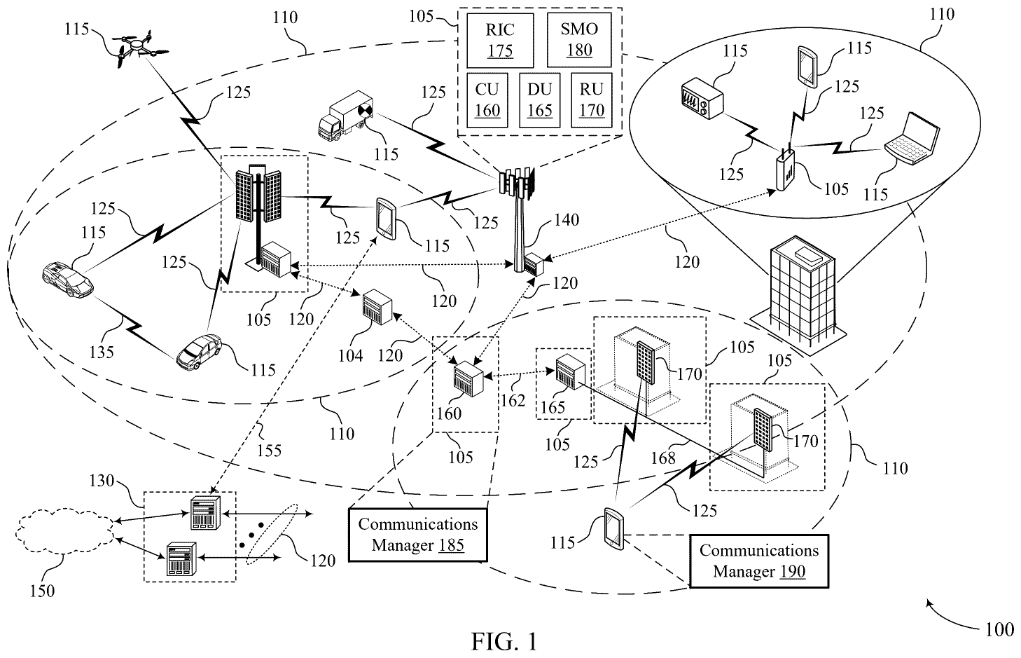

FIG. 1 shows an example of a wireless communications system 100 that supports techniques for multi-cell scheduling with different SCSs or carrier types in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs). The network entities 105 may each include a communications manager 185 that is configured to facilitate or otherwise perform wireless communications.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology.

Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1. The UEs 115 may each include a communications manager 190 that is configured to facilitate or otherwise perform wireless communications.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled

IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for multi-cell scheduling with different SCSs or carrier types as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

Techniques described herein, in addition to or as an alternative to be carried out between UEs 115 and network entities 105 (e.g., base stations), may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively, be performed by components of the disaggregated RAN architecture (e.g., IAB nodes, DUs, CUs, etc.).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and SCS may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported SCS, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (cMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the respective wireless devices of the wireless communications system 100 (e.g., UEs 115, network entities 105, IoT devices, IAB nodes, etc.) may support DCI formats (e.g., DCI formats 0_3 or 1_3) that enable multi-cell scheduling across scheduled cells with different SCSs, different carrier types, and/or other differing parameters/characteristics. In particular, the wireless communications system 100 may support DCI formats that include different sub-fields (e.g., sub-fields of a Type 1A field) that indicate common cell parameters for scheduled cells with different SCSs and/or carrier types.

For example, a UE 115 of the wireless communications system 100 may receive a DCI message that from a network entity 105 schedules communications (e.g., PDSCH, PUSCH) on a first set of scheduled cells associated with a first SCS and/or first carrier type and a second set of scheduled cells associated with a second SCS and/or carrier type. In this example, the DCI message may include two different subsets of bits (e.g., two different sub-fields) of a Type 1A field that indicate values of a cell parameter for two respective sets of scheduled with different SCSs/carrier types. For instance, a first sub-field may indicate a BWP indicator for the first set of scheduled cells associated with the first SCS, and a second sub-field may indicate a BWP indicator for the second set of scheduled cells associated with the second SCS.

Techniques described herein may facilitate improved multi-cell scheduling. In particular, aspects of the present disclosure may enable DCI messages to indicate cell parameters for scheduled cells with different SCSs and/or carrier types, thereby reducing the quantity of control signaling exchanged within the network (e.g., by preventing the network from having to send different DCI messages to schedule communications on scheduled cells with different SCSs/carrier types). Further, by reducing the amount of control signaling used to schedule communications at the UE, aspects of the present disclosure may reduce the power consumption at the UE, thereby improving battery life.

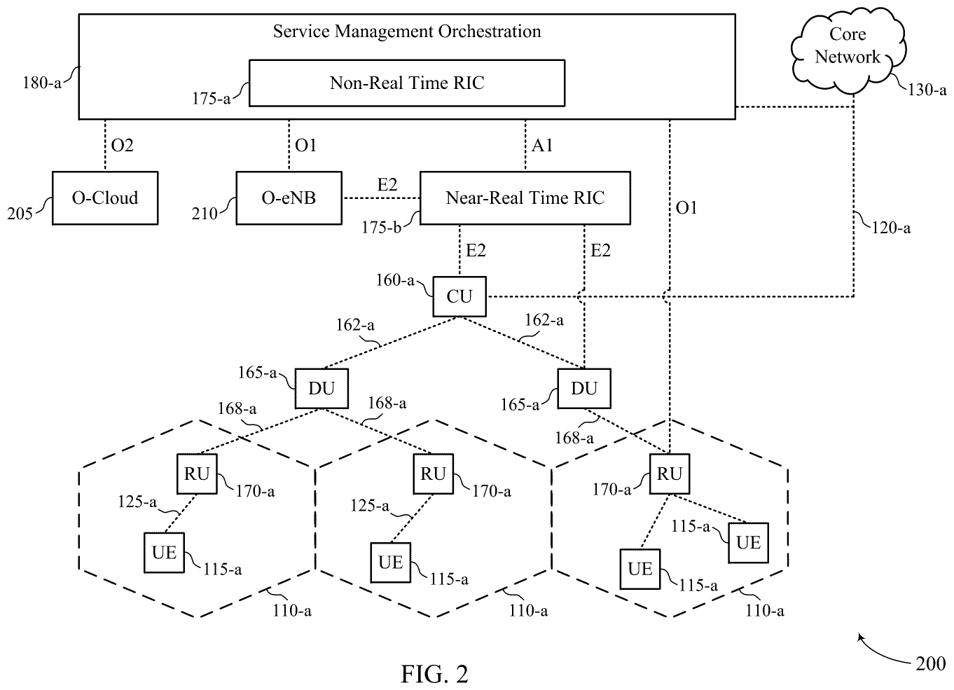

FIG. 2 shows an example of a network architecture 200 (e.g., a disaggregated base station architecture, a disaggregated RAN architecture) that supports techniques for multi-cell scheduling with different SCSs or carrier types in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., Al policies).

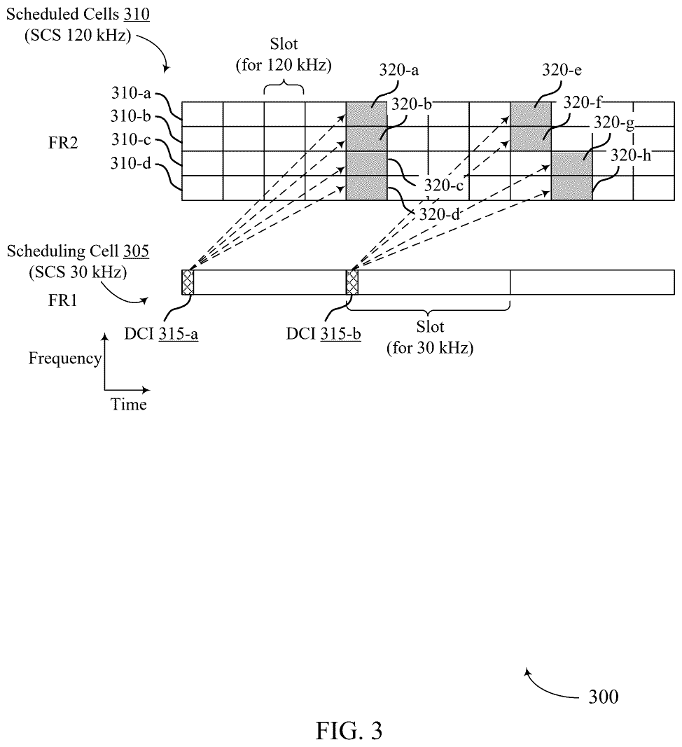

FIG. 3 shows an example of a scheduling configuration 300 that supports techniques for multi-cell scheduling with different SCSs or carrier types in accordance with one or more aspects of the present disclosure. In some examples, aspects of the wireless scheduling configuration 300 may implement, or be implemented by, aspects of the wireless communications system 100, the network architecture 200, or both.

As noted previously herein, some wireless communications systems may support multi-carrier or multi-cell operation to increase data rates and decrease latency. For example, 5G commercial networks may implement multi-cell (e.g., multi-carrier) operation by aggregating various spectrum resources in order to provide high data rate and low latency communications.

Some wireless communications systems may implement cross-cell or multi-cell scheduling. In cross-cell scheduling, a UE 115 may receive a DCI message via a “scheduling cell” that schedules communication(s) on a different “scheduled cell.” Similarly, in multi-cell scheduling, the UE may receive a DCI message via the scheduling cell that schedules communications on multiple different scheduled cells. For example, DCI formats 0_3 or 1_3 may be used to schedule up to four cells (with the limitation of a single PUSCH/PDSCH scheduled per cell), and DCI formats 0_3 or 1_3 may schedule up to eight PUSCH or PDSCH transmissions. Some wireless networks that support communications within Frequency Range 2 (FR2) with high SCS may support multi-PDSCH/PUSCH scheduling, where a single DCI format 0_1 or 1_1 may be used to schedule up to eight PUSCHs or PDSCHs on a single serving cell in order to save UE 115 power consumption and reduce PDCCH overhead.

An example of multi-carrier scheduling is provided in the scheduling configuration 300 illustrated in FIG. 3. As shown in FIG. 3, a UE 115 may receive DCI messages 315-a, 315-b via a scheduling cell 305, where the DCI messages 315 schedule communications (e.g., PUSCH, PDSCH communications) on multiple scheduled cells 310-a, 310-b, 310-c, and 310-d (e.g., multi-cell or multi-carrier scheduling). For example, the first DCI message 315-a may schedule communications within slots 320-a, 320-b, 320-c, and 320-d of the respective scheduled cells 310-a, 310-b, 310-c, and 310-d. Similarly, the second DCI message 315-b may schedule communications within slots 320-e, 320-f, 320-g, and 320-h of the respective scheduled cells 310-a, 310-b, 310-c, and 310-d. In this example, the scheduling cell 305 may be associated with a first SCS (e.g., 30 kHz), and the scheduled cells 310 may be associated with a second SCS (e.g., 120 kHz). In some aspects, the DCI messages 315-a, 315-b may include DCI formats 0_3 or 1_3.

The DCI formats 0_3 and 1_3 have been introduced for multi-cell scheduling. In particular, DCI format 1_3 may be used for PDSCH scheduling on multiple scheduled cells with the same SCS and same carrier type, and DCI format 0_3 may be used for PUSCH scheduling on multiple scheduled cells with the same SCS and same carrier type. The respective DCI formats 1_3 and 0_3 include various fields that are usable for carrying out multi-cell scheduling. fields for multi-cell scheduling.

In order to save overhead within DCI messages 315, some DCI fields within the DCI messages 315 may be designed as common fields for the scheduled cells 310 by the same DCI format. That is, the DCI messages 315-a, 315-b may include common fields that indicate cell parameters/characteristics that are shared across all the scheduled cells 310-a, 310-b, 310-c, and 310-d. Several example compression schemes that may be used to reduce overhead of DCI messages 315 are illustrated in Table 1 below:

TABLE 1
Example DCI Format Compression Schemes

| Type of DCI Size | DCI format 0_3 | DCI format 1_3 |
|---|---|---|
| Compression Scheme | (PUSCH) | (PDSCH) |
| Type 1A: Single common | BWP indicator, frequency | BWP indicator, VRB-to- |
| field value applied to all | hopping (FH) flag, OLPC | PRB, PRB bundling size, |
| the co-scheduled cells | set, demodulation | DMRS seq init., Antenna |
| | reference signal (DMRS) | port(s) (configurable to be |
| | seq init., SRS res | per-cell field), Priority |
| | (configurable to be per-cell | indicator, PDCCH |
| | field), Antenna port(s) | monitoring adaptation, |
| | (configurable to be per-cell | min-K0-offset, |
| | field), TPMI (configurable | Channel Access-CPext |
| | to be per-cell field), | |
| | Priority indicator, min- | |
| | K2-offset, ChannelAccess- | |
| | CPext-CAPC | |
| Type 1B: Single common | TDRA (<=6 bits), SRS | TDRA (<=5 bits), Rate- |
| field with each codepoint | request (<=4 bits), SRS | matching (<=4 bits), ZP |
| mapped to a RRC | offset (<=3 bits), | CSI-RS (<=3 bits), TCI |
| configured value to each | | state (<=4 bits), SRS |
| of the co-scheduled cells | | request (<=4 bits), SRS |
| | | offset (<=3 bits) |
| Coarser granularity | FDRA (larger RBG for | FDRA (larger RBG for |
| configurable per cell | Type-0, RBG-level RIV | Type-0, RBG-level RIV |
| | for Type-1) | for Type-1) |
| Smaller field size | RV, HARQ process | RV, HARQ process |
| configurable per cell | number | number |

Type 1A fields are used to indicate cell parameters/characteristics that are to be applied to all the co-scheduled cells 310. For example, the DCI message 315-a may include a Type 1A field that indicates a BWP indicator that is to be applied to all the scheduled cells 310-a, 310-b, 310-c, and 310-d. For instance, if a DCI message schedules communications on component carriers/cells {1, 2, 3}, and the DCI message includes a Type 1A field that has two bits indicating “01,” the value “01” is interpreted as “01” for each of the respective component carriers/cells {1, 2, 3}. Comparatively, Type 1B fields indicate a codepoint that is mapped to an RRC-configured value that is used to determine cell parameters/characteristics for all the co-scheduled cells. With Type 1B fields, there is still a single field for all the co-scheduled cells. However, RRC can flexibly configure a mapping between the codepoint and the indicated value. For instance, if a DCI message schedules communications on component carriers/cells {1, 2, 3}, and a Type 1B field of the DCI message has two bits indicating “01,” the value “01” can be interpreted as “01” for CC1, “10” for CC2, “11” for CC3, where the interpretation mapping is configurable by RRC. It is noted herein that the compression schemes illustrated in Table 1 above are provided solely for illustrative purposes.

In this regard, some wireless networks may support techniques for combining multi-cell scheduling and multi-PDSCH/PUSCH scheduling to fully exploit the gain of power saving and PDCCH overhead reduction so that one DCI format 0_3 or 1_3 can schedule multiple cells with one or multiple PUSCHs/PDSCHs per scheduled cell. Such multi-cell scheduling may be particularly useful when a DCI message 315 within the scheduling cell 305 associated with Frequency Range 1 (FR1) and a lower SCS schedules communications on multiple scheduled cells 310 associated with FR2 and a higher SCS.

However, the flexibility and utility of multi-cell scheduling has been hampered or otherwise limited in some wireless communications systems. In particular, some important use cases have been excluded from multi-cell scheduling configurations, such as multi-cell scheduling across co-scheduled cells with different SCSs and/or different carrier types. Co-scheduled cells/carriers with different SCSs may have various commercial applications for operators (e.g., 3.5 GHz TDD+Sub-3 GHz FDD, FR1+FR2, etc.).

Stated differently, some wireless communications systems may not allow for multi-carrier scheduling across multiple scheduled cells 310 with different SCSs or carrier types. That is, some wireless communications systems do not allow for a single DCI message 315 to schedule communications across multiple scheduled cells 310 with different SCSs and/or different carrier types. For example, referring to FIG. 3, some wireless communications systems may not enable the DCI message 315-a to schedule the communications within the slots 320-a, 320-b, 320-c, and 320-d if the respective scheduled cells 310-a, 310-b, 310-c, and 310-d are associated with different SCSs and/or carrier types.

Accordingly, aspects of the present disclosure relate to new structures for DCI messages 315 (e.g., DCI formats 0_3 or 1_3) that enable multi-cell scheduling across scheduled cells 310 with different SCSs and/or different carrier types. In particular, aspects of the present disclosure are directed to DCI formats for DCI messages 315 that include different sub-fields (e.g., sub-fields of a Type 1A field) that indicate common cell parameters for scheduled cells 310 with different SCSs and/or carrier types.

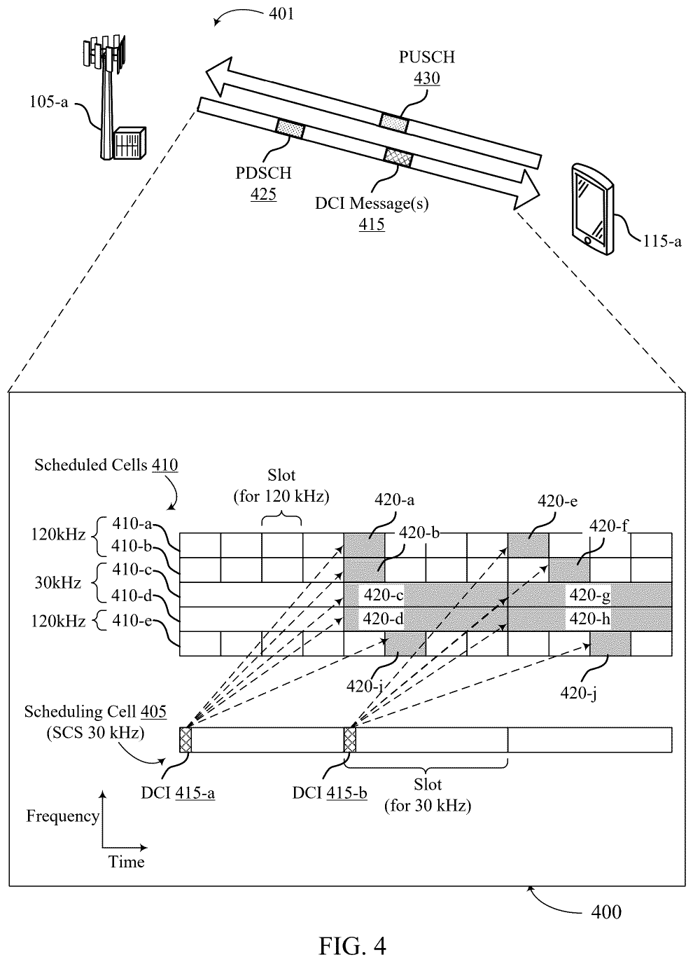

Attendant advantages of the present disclosure are further shown and described with reference to FIGS. 4-7.

FIG. 4 shows an example of a wireless communications system 400 that supports techniques for multi-cell scheduling with different SCSs or carrier types in accordance with one or more aspects of the present disclosure. In some examples, aspects of the wireless communications system 400 may implement, or be implemented by, aspects of the wireless communications system 100, the network architecture 200, the scheduling configuration 300, or any combination thereof. In particular, the wireless communications system 400 may support signaling, configurations, and DCI formats that are usable for performing multi-cell scheduling across scheduled cells with different SCSs, different carrier types, or both, as described herein.

The wireless communications system 400 may include a network entity 105-a and a UE 115-a, which may be examples of wireless devices as described herein. In some aspects, the network entity 105-a and the UE 115-a may communicate with one another using a communication link 401, which may be an example of an NR or LTE link, sidelink (e.g., PC5 link), and the like, between the respective devices. In some cases, the communication link 401 may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 401, and one or more components of the network entity 105-a may transmit downlink signals, such as downlink control signals or downlink data signals, to the UE 115-a using the communication link 401.

As noted previously herein, some wireless communications systems implement cross-cell or multi-cell scheduling. In cross-cell scheduling, The UE 115-a may receive a DCI message 415 via a “scheduling cell 405” that schedules communication(s) (e.g., PDSCH communications 425, PUSCH communications 430) on a different “scheduled cell 410.” Similarly, in multi-cell scheduling, the UE 115-a may receive a DCI message 415 via the scheduling cell 405 that schedules communications on multiple different scheduled cells 410. For example, DCI formats 0_3 or 1_3 may be used to schedule up to four cells, and DCI formats 0_3 or 1_3 may schedule up to eight PUSCH communications 430 or PDSCH communications 425.

Scheduling multiple shared channel communications via a single DCI message 415 may save UE power (e.g., by reducing the quantity of PDCCH occasions for the UE 115-a to monitor) and may reduce PDCCH overhead. However, some wireless communications may not allow for multi-cell scheduling when the scheduled cells 410 are associated with different SCSs and/or carrier types. In general, different SCSs and different carrier types are used for different frequency bands that exhibit quite different characteristics (e.g., FR1-FDD (15 kHz), FR1-TDD (30 kHz), FR2-1 (120 kHz), FR2-2 (120 kHz or 480/960 kHz)). As such, the network scheduling strategy or UE 115-a implementation may be quite different for different frequency bands where SCS or carrier type is not the same.

In this regard, in some wireless communications systems, multi-carrier scheduling is only able to be performed across scheduled cells 410 that exhibit the same SCS and/or carrier type. As such, DCI fields within DCI messages 415 are common for all scheduled cells 410 that are scheduled by the DCI format, as all the scheduled cells 410 are assumed to have the same SCS/carrier type. Therefore, these common DCI fields (e.g., Type 1A fields) that are applicable to all the scheduled cells 410 (Type-1A fields) are inconvenient and inflexible for multi-cell scheduling across scheduled cells 410 that have different SCSs and/or different carrier types.

Stated differently, scheduled cells 410 with different SCSs or carrier types may exhibit different cell parameters or characteristics, and DCI formats may not provide the flexibility to indicate the respective cell parameters for the different cells with different SCSs/carrier types.

Accordingly, aspects of the present disclosure are directed to signaling, configurations, and DCI message formats (e.g., DCI formats 0_3 or 1_3) that enable multi-cell scheduling across scheduled cells 410 with different SCSs and/or different carrier types. In particular, aspects of the present disclosure are directed to DCI formats that include different sub-fields (e.g., sub-fields of a Type 1A field) that indicate common cell parameters for scheduled cells 410 with different SCSs and/or carrier types.

For example, as shown in FIG. 4, the UE 115-a may receive DCI messages 415-a, 415-b via a scheduling cell 405, where the DCI messages 415 schedule communications (e.g., PDSCH communications 425, PUSCH communications 430) on multiple scheduled cells 410-a, 410-b, 410-c, 410-d, and 410-e (e.g., multi-cell or multi-carrier scheduling). In some aspects, the DCI messages 415-a, 415-b may include DCI formats 0_3 or 1_3.

For example, the first DCI message 415-a may schedule communications (e.g., PDSCH communications 425, PUSCH communications 430) within slots 420-a, 420-b, 420-c, 420-d, and 420-i of the respective scheduled cells 410-a, 410-b, 410-c, 410-d, and 410-e. Similarly, the second DCI message 415-b may schedule communications within slots 420-c, 420-f, 420-g, 420-h, and 420-j of the respective scheduled cells 410-a, 410-b, 410-c, 410-d, and 410-c. In this example, the first scheduled cell 410-a, the second scheduled cell 410-b, and the fifth scheduled cell 410-e may be associated with a first SCS (e.g., 30 kHz), where the third scheduled cell 410-c and the fourth scheduled cell 410-d may be associated with a second SCS (e.g., 120 kHz). In this regard, aspects of the present disclosure are directed to techniques that enable multi-cell scheduling across scheduled cells 410 that are associated with different SCSs and/or different carrier types.

In some aspects, the SCSs for each of the scheduling cell 405 and scheduled cells 410 may be configured by the network via RRC signaling, and may be further dynamically indicated or switched via DCI messages 415 and/or MAC timers. As noted previously herein, in some cases, the scheduling cell 405 and the scheduled cells 410 may be associated with different frequency ranges or frequency bands. For instance, in some cases, the scheduling cell 405 may be associated with FR1, and the scheduled cells 410 may be associated with FR2 (or vice versa).

The scheduled cells 410 may exhibit different combinations of SCSs and/or carrier types. For example, in additional or alternative cases, the first scheduled cell 410-a and the third scheduled cell 410-c may be associated with the 120 kHz SCS, and the second scheduled cell 410-b and the fourth scheduled cell 410-d may be associated with the 30 kHz SCS. In yet other cases, the scheduled cells 410 may be associated with three or more SCSs (e.g., first SCS for the first scheduled cell 410-a, second SCS for the second scheduled cell 410-b, third SCS for the third scheduled cell 410-c, etc.). For example, in some cases, the fifth scheduled cell 410-e may be associated with a third SCS, such as 60 kHz.

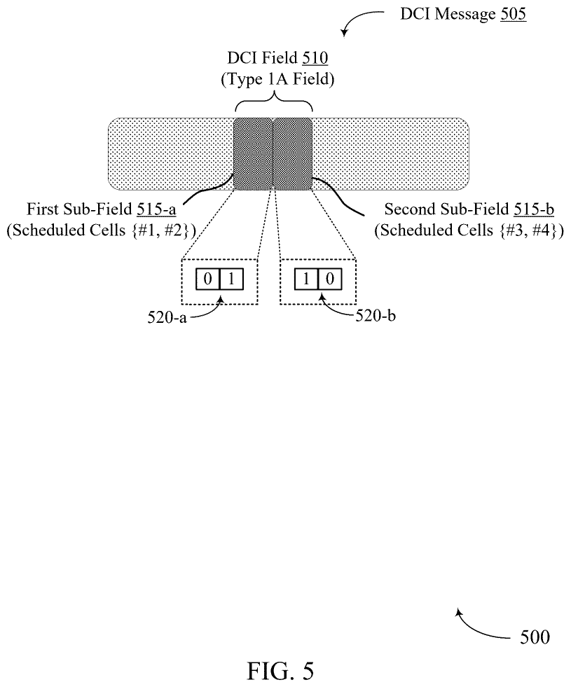

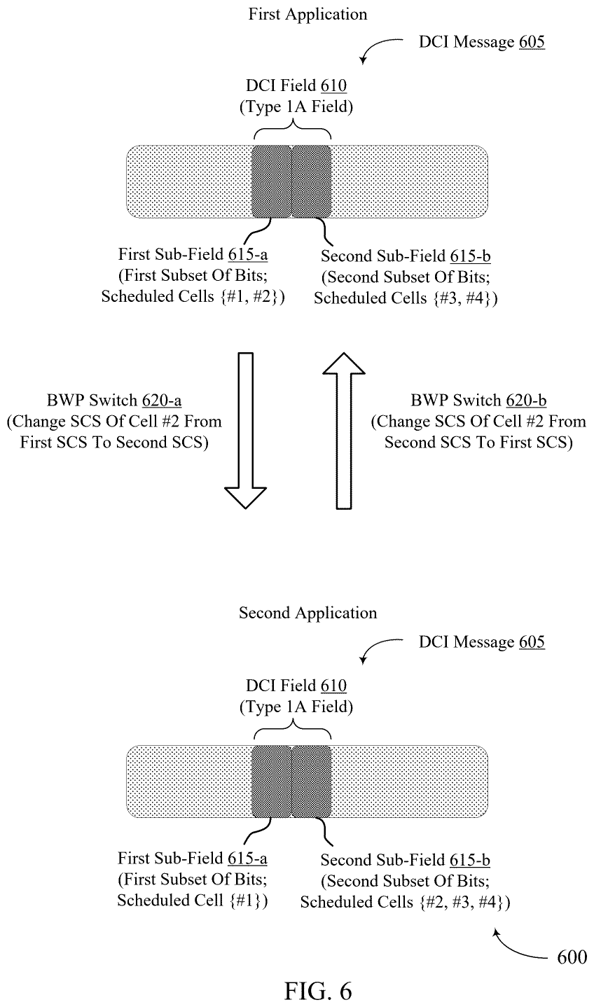

The structure or format of the DCI messages 415 that enable multi-cell scheduling across scheduled cells 410 is further shown and described in FIGS. 5 and 6.

FIG. 5 shows an example of a DCI message format 500 that supports techniques for multi-cell scheduling by the same DCI format for co-scheduled cells with different SCSs or carrier types in accordance with one or more aspects of the present disclosure. In some examples, aspects of the DCI message format 500 may implement, or be implemented by, aspects of the wireless communications system 100, the network architecture 200, the scheduling configuration 300, the wireless communications system 400, or any combination thereof. In particular, the DCI message format 500 may be usable for performing multi-cell scheduling across scheduled cells with different SCSs, different carrier types, or both, as described herein.

The DCI message 505 shown in FIG. 5 may be an example message format of the DCI messages 415 shown and described in FIG. 4. As shown in FIG. 5, the DCI message 505 may include a DCI format 0_3 or DCI format 1_3 that schedules PDSCH communications 425 and/or PUSCH communications 430 within scheduled cells {#1, #2, #3, #4} (e.g., scheduled cells 410-a, 410-b, 410-c, 410-d). In this example, scheduled cells {#1, #2} (e.g., scheduled cells 410-a, 410-b) may be associated with a first SCS and/or first carrier type, and scheduled cells {#3, #4} (e.g., scheduled cells 410-c, 410-d) may be associated with a second SCS and/or second carrier type. In additional or alternative cases, the scheduled cells may be associated with the same SCS and/or same carrier type.

In some aspects, the DCI message 505 may include a DCI field 510, such as a Type 1A field, that is used to indicate parameter values for cell parameters associated with the scheduled cells {#1, #1, #3, #4} (e.g., scheduled cells 410-a, 410-b, 410-c, 410-d). For example, as shown in Table 1 above, the DCI field 510 may include a Type 1A field that is used to indicate a BWP indicator for the scheduled cells 410. The DCI message 505 may include other DCI fields 510 that are used to communicate other cell parameters associated with the scheduled cells 410 (e.g., first Type 1A DCI field 510 for indicating BWP indicator(s), second Type 1A DCI field 510 for indicating FH flags, third Type 1A DCI field 510 for indicating priority indicator(s), etc.).

Type 1A DCI fields 510 for DCI format 0_3 may be used to indicate cell parameters or characteristics including, but not limited to, a BWP indicator, a FH flag, a DMRS sequence initialization, a priority indicator, a min-K2-offset, and a ChannelAccess-CPext-CAPC. Comparatively, Type 1A DCI fields 510 for DCI format 1_3 may be used to indicate cell parameters or characteristics including, but not limited to, a BWP indicator, a VRB-to-PRB mapping, a PRB bundling size, a DMRS sequence initialization, a priority indicator, a min-K0-offset, and a ChannelAccess-CPext.

In this example, the DCI field 510 may include two sub-fields 515: (1) a first sub-field 515-a for cells {#1, #2} (e.g., scheduled cells 410-a, 410-b), and (2) a second sub-field 515-b for cells {#3, #4} (e.g., scheduled cells 410-c, 410-d). In particular, as described previously herein, each respective sub-field 515 may include or otherwise be associated with corresponding subsets of one or more bits. For instance, as shown in FIG. 5, the first sub-field 515-a may include or otherwise be associated with a first subset of bits 520-a, and the second sub-field 515-b may include or otherwise be associated with a second subset of bits 520-a. The respective subsets of bits 520 may each include one or more bits, and may include the same or different quantities of bits in some implementations. As noted previously herein, the terms “sub-fields” and “subsets of bits” may be used interchangeably with one another for the purposes of the present disclosure.

In this regard, the DCI field 510 may include subsets of bits 520 (e.g., sub-fields 515) that are defined on a per-SCS and/or per-carrier type basis. For example, in cases where the DCI field 510 is used to indicate a priority indicator for scheduled cells {#1, #2, #3, #4} (e.g., scheduled cells 410-a, 410-b, 410-c, 410-d), the first sub-field 515-a (e.g., first subset of bits 520-a) may be used to indicate the priority indicator for scheduled cells {#1, #2} (e.g., scheduled cells 410-a, 410-b), and the second sub-field 515-b (e.g., second subset of bits 520-b) may be used to indicate the priority indicator for scheduled cells {#3, #4} (e.g., scheduled cells 410-c, 410-d). In this regard, the value of the first sub-field 515-a (e.g., value(s) of the first subset of bits 520-a) may be applied to the scheduled cells {#1, #2}, and the value of the second sub-field 515-b (e.g., value(s) of the second subset of bits 520-b) may be applied to the scheduled cells {#3, #4}.

As noted previously herein, for the purposes of the present disclosure, the term “sub-field” may be used to refer to a portion or subset of a DCI field, and may therefore be used to refer to a subset of bits, a “block” of a DCI field (e.g., bit block), a “sub-block” of a DCI field, or any combination thereof. In this regard, the first and second sub-fields 515-a, 515-b may additionally, or alternatively, be referred to as first and second blocks, first and second bit blocks, first and second sub-blocks, etc.

In some aspects, the “sub-fielding” of the DCI field 510 may be based on the SCSs of the scheduled cells {#1, #2, #3, #4} (e.g., based on the SCSs of scheduled cells 410-a, 410-b, 410-c, 410-d). In other words, the first sub-field 515-a (e.g., first subset of bits 520-a) may be applicable to the scheduled cells {#1, #2} based on the scheduled cells {#1, #2} being associated with the same SCS. In this regard, since the SCSs for the scheduled cells may be configured via RRC signaling and/or dynamically indicated or switched via DCI messages 505 and/or MAC timers, the quantity of sub-fields 515 for the Type 1A DCI field 510 may be based on signaling provided to the UE 115.

In particular, the quantity of sub-fields 515 (quantity of subsets of bits 520) for the DCI field 510 may correspond to the quantity of scheduled cells with unique SRSs. For example, if the DCI message 505 schedules communications across scheduled cells 410 associated with two different SRSs (e.g., two unique SRSs), the DCI field 510 may include two different sub-fields 515 or two subsets of bits 520 (e.g., first sub-field 515-a for cells associated with the first SRS, second sub-field 515-b for cells associated with the second SRS). Comparatively, if the DCI message 505 schedules communications across scheduled cells 410 associated with three different SRSs (e.g., three unique SRSs), the DCI field 510 may include there different sub-fields 515 or three subsets of bits 520 (e.g., first sub-field 515-a for cells associated with the first SRS, second sub-field 515-b for cells associated with the second SRS, and third sub-field for cells associated with the third SRS).

In additional or alternative aspects, the “sub-fielding” of the DCI field 510 may be based on the carrier type of the scheduled cells {#1, #2, #3, #4} (e.g., based on the carrier type of scheduled cells 410-a, 410-b, 410-c, 410-d). The carrier type for each scheduled cell 410 may be determined or identified based on which frequency band the respective scheduled cell 410 belongs to. For example, if the scheduled cell {#1} (e.g., scheduled cell 410-a) is in band n3, the scheduled cell {#1} may be FR1-FDD. Similarly, if the scheduled cell {#1} (e.g., scheduled cell 410-b) is in band n77 or band n257, the scheduled cell {#1} may be FR1-TDD or FR2-1, respectively. In this regard, the quantity of sub-fields 515 for the Type IA DCI field 510 may be based on which frequency bands the DCI message 505 schedules communications within.

In particular, the quantity of sub-fields 515 (e.g., the quantity of subsets of bits 520) for the DCI field 510 may correspond to the quantity of scheduled cells with unique carrier types. For example, if the DCI message 505 schedules communications across scheduled cells 410 associated with two different carrier types (e.g., two unique carrier types), the DCI field 510 may include two different sub-fields 515 (e.g., first sub-field 515-a for cells associated with the first carrier type, second sub-field 515-b for cells associated with the second carrier type). Comparatively, if the DCI message 505 schedules communications across scheduled cells 410 associated with three different carrier types (e.g., three unique carrier types), the DCI field 510 may include there different sub-fields 515 (e.g., first sub-field 515-a for cells associated with the first carrier type, second sub-field 515-b for cells associated with the second carrier type, and third sub-field for cells associated with the third carrier type).

In additional or alternative aspects, the “sub-fielding” of the DCI field 510 may be based on other parameters or characteristics of scheduled cells {#1, #2, #3, #4} that are different from SCS and/or carrier type. In other words, the DCI field 510 may schedule multiple different scheduled cells with the same SCS and/or the same carrier type, but may have multiple different sub-fields 515 (e.g., multiple different subsets of bits 520) that correspond to different parameters or other characteristics of the scheduled cells.

In some aspects, the respective sub-fields 515/subsets of bits 520 (and/or other portions of the DCI message 505) may explicitly indicate which respective scheduled cells, SRSs, and/or carrier types that the respective sub-fields 515 are to be applied for. That is, the first sub-field 515-a may explicitly indicate (e.g., via one or more bit fields) that first sub-field 515-a is to be applied to scheduled cells {#1, #2}, or that the first sub-field 515-a is to be applied to all scheduled cells associated with the first SCS or first carrier type. Similarly, in some cases, the second sub-field 515-b may explicitly indicate that second sub-field 515-b is to be applied to scheduled cells {#3, #4}, or that the second sub-field 515-b is to be applied to all scheduled cells associated with the second SCS or second carrier type.

In additional or alternative implementations, relationships between the respective sub-fields 515 and corresponding scheduled cells may be implicitly determined or defined. For example, the UE 115 may determine that the first sub-field 515-a is to be applied to the scheduled cell {#1} (e.g., first scheduled cell 410-a) based on the scheduled cell {#1} being associated with the lowest cell ID and/or the lowest SCS. In this example, the UE 115 may further identify that the first sub-field 515-a is also to be applied to the scheduled cell {#2} based on the scheduled cell {#2} being associated with the same SCS as the first scheduled cell {#1}. In this regard, the UE 115 may be configured to determine which sub-fields 515 apply to which sets of scheduled cells 410 by comparing cell identifiers and/or SCSs associated with the respective scheduled cells 410.

FIG. 6 shows an example of a DCI message format 600 that supports techniques for multi-cell scheduling with different SCSs or carrier types in accordance with one or more aspects of the present disclosure. In some examples, aspects of the DCI message format 600 may implement, or be implemented by, aspects of the wireless communications system 100, the network architecture 200, the scheduling configuration 300, the wireless communications system 400, the DCI message format 500, or any combination thereof. In particular, the DCI message format 600 may be usable for performing multi-cell scheduling across scheduled cells with different SCSs, different carrier types, or both, as described herein.

The DCI message 605 shown in FIG. 6 may be an example message format of the DCI messages 415 shown and described in FIG. 4, and/or the DCI message 505 shown and described in FIG. 5.

In some cases, the SCS for a scheduled cell 410 may change. For example, a BWP switch applied to a scheduled cell 410 may effectively switch the SCS of the scheduled cell 410. In such cases, if the SCS of a scheduled cell 410 is switched (e.g., via BWP switching), the interpretation or application of the respective sub-field 615 for the scheduled cell 410 may also be switched.

For example, the DCI message 605 may include a DCI format 0_3 or DCI format 1_3 that schedules PDSCH communications 425 and/or PUSCH communications 430 within scheduled cells {#1, #2, #3, #4} (e.g., scheduled cells 410-a, 410-b, 410-c, 410-d). Referring to the first application in FIG. 6, scheduled cells {#1, #2} (e.g., scheduled cells 410-a, 410-b) may be associated with a first SCS, and scheduled cells {#3, #4} (e.g., scheduled cells 410-c, 410-d) may be associated with a second SCS. The DCI message 605 may include a DCI field 610, such as a Type 1A field, that is used to indicate parameter values for cell parameters associated with the scheduled cells {#1, #2, #3, #4}. For instance, referring to the first application in FIG. 6, the DCI field 610 may include two sub-fields 615: (1) a first sub-field 615-a for cells {#1, #2} (e.g., scheduled cells 410-a, 410-b) associated with the first SCS, and (2) a second sub-field 615-b for cells {#3, #4} (e.g., scheduled cells 410-c, 410-d) associated with the second SCS. In this regard, the DCI field 510 may include sub-fields that are defined on a per-SCS basis. As shown and described previously with respect to FIG. 5, each of the respective sub-fields 615-a, 615-b of the DCI message 605 may include or otherwise be associated with corresponding subsets of one or more bits. As such, the first and second “sub-fields 615-a, 615-b” shown and described in FIG. 6 may also be understood to refer to first/second subsets of one or more bits.

In some aspects, the network may indicate a BWP switch 620-a that changes the SCS of scheduled cell {#2} (e.g., second scheduled cell 410-b) from the first SCS to the second SCS. In this regard, the interpretation or application of the respective sub-fields 615 of the DCI message 605 may change based on the BWP switch 620-a (e.g., based on the changed SCS of the second scheduled cell {#2}). For example, referring to the second application in FIG. 6, the first sub-field 615-a may be applied to cell {#1} associated with the first SCS, and the second sub-field 615-b may be applied to {#2, #3, #4} associated with the second SCS. In other words, the BWP switch 620-a may change how the sub-fields 615 of the DCI message 605 are applied or interpreted across the scheduled cells. Similarly, another BWP switch 620-b that changes the SCS of scheduled cell {#2} from the second SCS back to the first SCS may also change the application/interpretation of the DCI message 605 back to the first application.

In some aspects, each sub-field 615 may be present in the DCI message 605 as long as at least one scheduled cell 410 with the associated SCS/carrier type is configured in the set of scheduled cells 410 for multi-cell PDSCH/PUSCH scheduling by a DCI format 0_3 or DCI format 1_3. That is, the first sub-field 615-a may be present in the DCI message 605 so long as the DCI message 605 schedules a PUSCH/PDSCH on at least one scheduled cell 410 associated with the first SCS. Conversely, the first sub-field 615-a may be dropped or otherwise omitted from the DCI message 605 if the DCI message 605 does not schedule any communications on a scheduled cell 410 associated with the first SCS (e.g., due to a BWP switch 620 that changes the SCS of the scheduled cells 410).

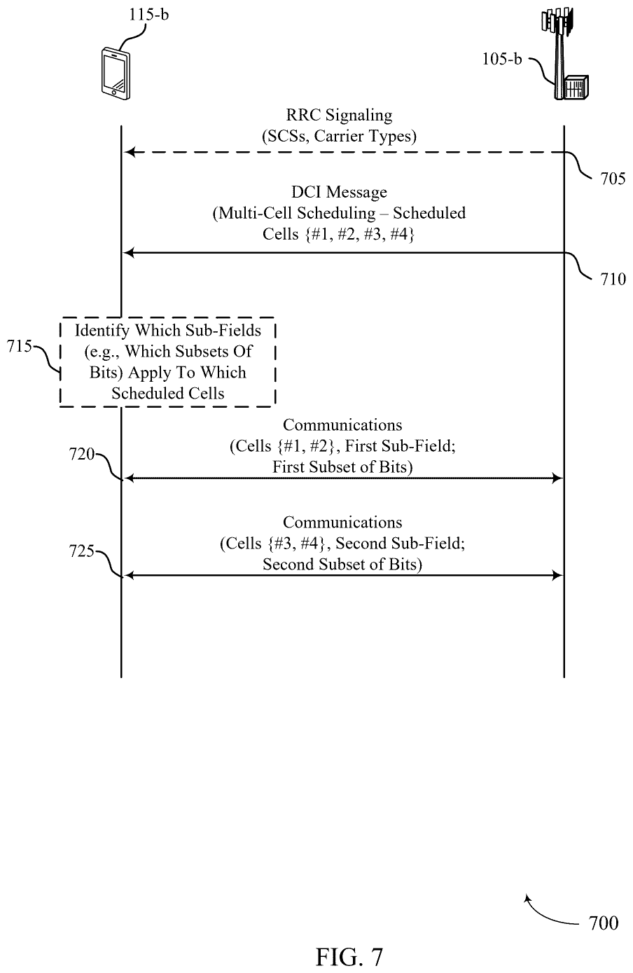

FIG. 7 shows an example of a process flow 700 that supports techniques for multi-cell scheduling with different SCSs or carrier types in accordance with one or more aspects of the present disclosure. In some examples, aspects of the process flow 700 may implement, or be implemented by, aspects of the wireless communications system 100, the network architecture 200, the scheduling configuration 300, the wireless communications system 400, the DCI message formats 500-600, or any combination thereof. In particular, the process flow 700 may support signaling, configuration, and DCI formats that are usable for performing multi-cell scheduling across scheduled cells with different SCSs, different carrier types, or both, as described herein.

The process flow 700 includes a network entity 105-b and a UE 115-b, which may be examples of wireless devices as described herein. For example, the network entity 105-b and the UE 115-b illustrated in FIG. 7 may include examples of the network entity 105-a and the UE 115-a, respectively, as illustrated in FIG. 4.

In some examples, the operations illustrated in process flow 700 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 705, the UE 115-b may receive RRC signaling that indicates SCSs and/or carrier types associated with a set of serving cells usable for communications between the UE 115-b and the network entity 105-b. For example, as shown in FIG. 4, the RRC signaling may indicate that the first scheduled cell 410-a and the second scheduled cell 410-b are associated with a first SCS and/or first carrier type, and that the third scheduled cell 410-c and the fourth scheduled cell 410-d are associated with a second SCS and/or second carrier type.

In additional or alternative implementations, the RRC signaling may indicate other information that may be used to facilitate multi-cell scheduling. For example, the RRC signaling may indicate cell IDs associated with the respective serving cells. By way of another example, the RRC signaling may indicate whether sub-fielding of DCI fields for the purposes of multi-cell scheduling is based on SCSs or carrier types of scheduled cells scheduled by DCI messages.

At 710, the UE 115-b may receive a DCI message, where the DCI message schedules at least a first shared channel communication (e.g., first PDSCH/PUSCH) via a first cell and a second shared channel communication (e.g., second PDSCH/PUSCH), where the first cell and the second cell are associated with different SCSs, different carrier types, or both. In other words, the UE 115-b may receive a DCI message for multi-cell scheduling. In some aspects, the DCI message may include a DCI format 0_3 or a DCI format 1_3.

For example, as shown in FIG. 4, the DCI message 415-a may schedule communications on the first scheduled cell 410-a and the second scheduled cell 410-b associated with the first SCS and/or first carrier type, and may schedule communications on the third scheduled cell 410-c and the fourth scheduled cell 410-d associated with the second SCS and/or second carrier type.

In some aspects, the DCI message may include a field (e.g., Type 1A field) that includes multiple sub-fields that are used to indicate parameter values of a cell parameter for the scheduled cells. Parameter values that may be indicated via a Type 1A field are shown and described in Table 1 above. For example, as shown in FIG. 5, the DCI message 505 may include a DCI field 510 (e.g., Type 1A field) that is used to indicate a parameter value for the scheduled cells, such as a priority indicator for the scheduled cells. In this example, the DCI field 510 may include a first sub-field 515-a for indicating a first parameter value (e.g., first priority indicator) for the scheduled cells associated with the first SCS and/or first carrier type, and a second sub-field 515-b for indicating a second parameter value (e.g., second priority indicator) for the scheduled cells associated with the second SCS and/or second carrier type,

In some cases, the quantity of sub-fields of the DCI field of the DCI message may be based on (e.g., correspond to) the quantity of scheduled cells that are associated with unique SCSs and/or unique carrier types. For example, if the DCI message schedules communications across scheduled cells associated with two different carrier types (e.g., two unique carrier types), the DCI field may include two different sub-fields (e.g., first sub-field 515-a for cells associated with the first carrier type, second sub-field 515-b for cells associated with the second carrier type). Comparatively, if the DCI message schedules communications across scheduled cells associated with three different carrier types (e.g., three unique carrier types), the DCI field may include there different sub-fields (e.g., first sub-field 515-a for cells associated with the first carrier type, second sub-field 515-b for cells associated with the second carrier type, and third sub-field for cells associated with the third carrier type).

At 715, the UE 115-b may identify which sub-fields apply to which scheduled cell(s). In other words, the UE 115-b may identify that the first sub-field is to be applied to the first set of scheduled cells associated with the first SCS/first carrier type, and that the second sub-field is to be applied to the second set of scheduled cells associated with the second SCS/second carrier type.

In some aspects, the RRC signaling at 705 and/or the respective sub-fields of the DCI message at 710 (and/or other portions of the DCI message) may explicitly indicate which respective scheduled cells, SRSs, and/or carrier types that the respective sub-fields are to be applied for. That is, the first sub-field 515-a may explicitly indicate (e.g., via one or more bit fields) that first sub-field 515-a is to be applied to scheduled cells {#1, #2}, or that the first sub-field 515-a is to be applied to all scheduled cells associated with the first SCS or first carrier type. Similarly, in some cases, the second sub-field 515-b may explicitly indicate that second sub-field 515-b is to be applied to scheduled cells {#3, #4}, or that the second sub-field 515-b is to be applied to all scheduled cells associated with the second SCS or second carrier type.

In additional or alternative implementations, relationships between the respective sub-fields 515 and corresponding scheduled cells may be implicitly determined or defined. For example, the UE 115 may determine that the first sub-field 515-a is to be applied to the scheduled cell {#1} (e.g., first scheduled cell 410-a) based on the scheduled cell {#1} being associated with the lowest cell ID and/or the lowest SCS. In this example, the UE 115 may further identify that the first sub-field 515-a is also to be applied to the scheduled cell {#2} based on the scheduled cell {#2} being associated with the same SCS as the first scheduled cell {#1}. In this regard, the UE 115 may be configured to determine which sub-fields 515 apply to which sets of scheduled cells 410 by comparing cell identifiers and/or SCSs associated with the respective scheduled cells 410.

At 720, the UE 115-b may communicate (e.g., transmit, receive) the shared channel communication(s) via the first set of scheduled cells in accordance with the first parameter value for the cell parameter.

For example, as described previously herein, the first sub-field 515-a may indicate a first priority indicator that is to be applied to the first scheduled cell 410-a and the second scheduled cell 410-b. In this regard, the UE 115-b may communicate (e.g., transmit, receive) the scheduled shared channel communications via the first scheduled cell 410-a and the second scheduled cell 410-b in accordance with the first priority indicator indicated via the first sub-field. Similarly, the second sub-field 515-a may indicate a second priority indicator that is to be applied to the third scheduled cell 410-c and the fourth scheduled cell 410-d. In this regard, the UE 115-b may communicate (e.g., transmit, receive) the scheduled shared channel communications via the third scheduled cell 410-c and the fourth scheduled cell 410-d in accordance with the second priority indicator indicated via the second sub-field.

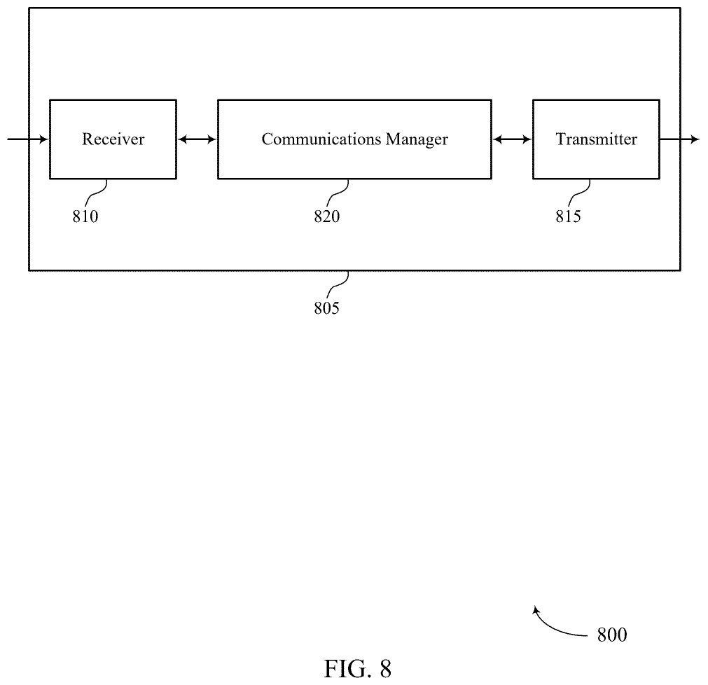

FIG. 8 shows a block diagram 800 of a device 805 that supports techniques for multi-cell scheduling with different SCSs or carrier types in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for multi-cell scheduling with different SCSs or carrier types). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for multi-cell scheduling with different SCSs or carrier types). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of techniques for multi-cell scheduling with different SCSs or carrier types as described herein. For example, the communications manager 820, the receiver 810, the transmitter 815, or various combinations or components thereof may be capable of performing one or more of the functions described herein (e.g., receiving, determining, transmitting).

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell. The communications manager 820 is capable of, configured to, or operable to support a means for communicating the first shared channel communication via the first cell in accordance with the first parameter value for the cell parameter. The communications manager 820 is capable of, configured to, or operable to support a means for communicating the second shared channel communication via the second cell in accordance with the second parameter value for the cell parameter.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques that facilitate improved multi-cell scheduling. In particular, aspects of the present disclosure may enable DCI messages to indicate cell parameters for scheduled cells with different SCSs and/or carrier types, thereby reducing the quantity of control signaling exchanged within the network (e.g., by preventing the network from having to send different DCI messages to schedule communications on scheduled cells with different SCSs/carrier types). Further, by reducing the amount of control signaling used to schedule communications at the UE, aspects of the present disclosure may reduce the power consumption at the UE, thereby improving battery life.

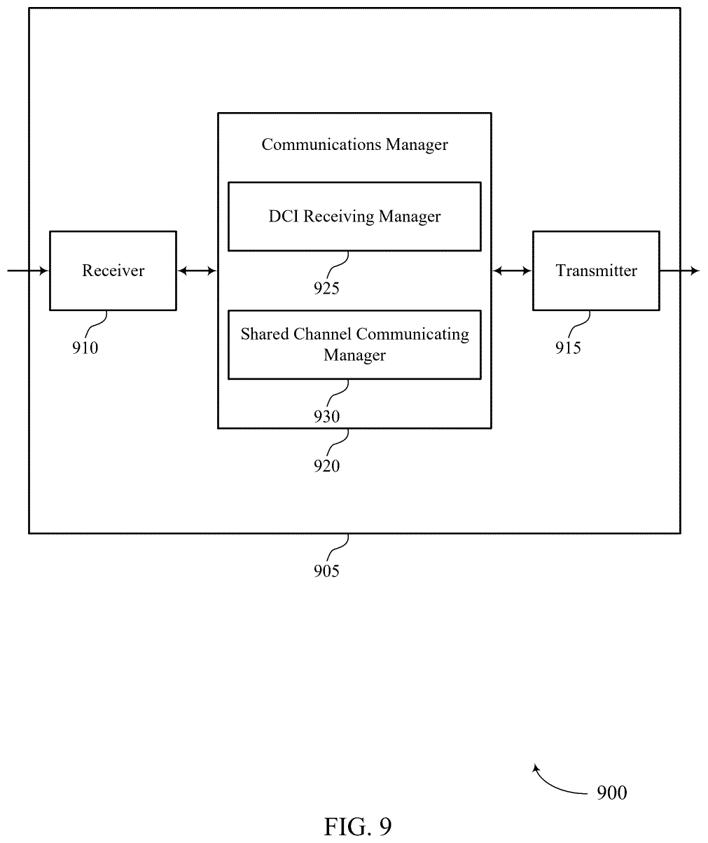

FIG. 9 shows a block diagram 900 of a device 905 that supports techniques for multi-cell scheduling with different SCSs or carrier types in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for multi-cell scheduling with different SCSs or carrier types). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for multi-cell scheduling with different SCSs or carrier types). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for multi-cell scheduling with different SCSs or carrier types as described herein. For example, the communications manager 920 may include a DCI receiving manager 925 a shared channel communicating manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The DCI receiving manager 925 is capable of, configured to, or operable to support a means for receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell. The shared channel communicating manager 930 is capable of, configured to, or operable to support a means for communicating the first shared channel communication via the first cell in accordance with the first parameter value for the cell parameter. The shared channel communicating manager 930 is capable of, configured to, or operable to support a means for communicating the second shared channel communication via the second cell in accordance with the second parameter value for the cell parameter.

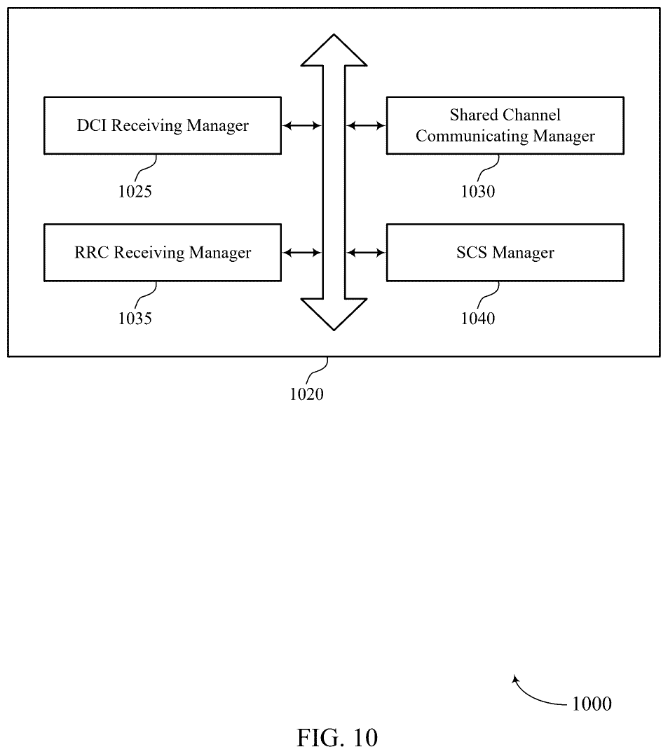

FIG. 10 shows a block diagram 1000 of a communications manager 1020 that supports techniques for multi-cell scheduling with different SCSs or carrier types in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for multi-cell scheduling with different SCSs or carrier types as described herein. For example, the communications manager 1020 may include a DCI receiving manager 1025, a shared channel communicating manager 1030, an RRC receiving manager 1035, an SCS manager 1040, or any combination thereof. Each of these components, or components or subcomponents thereof (e.g., one or more processors, one or more memories), may communicate, directly or indirectly, with one another (e.g., via one or more buses).

The DCI receiving manager 1025 is capable of, configured to, or operable to support a means for receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell. The shared channel communicating manager 1030 is capable of, configured to, or operable to support a means for communicating the first shared channel communication via the first cell in accordance with the first parameter value for the cell parameter. In some examples, the shared channel communicating manager 1030 is capable of, configured to, or operable to support a means for communicating the second shared channel communication via the second cell in accordance with the second parameter value for the cell parameter.

In some examples, the DCI message further schedules a third shared channel communication via a third cell associated with a third SCS, a third carrier type, or both. In some examples, the DCI message further includes a third sub-field that indicates a third parameter value for the cell parameter that is to be applied for the third cell.

In some examples, the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells including at least the first cell and the second cell, respectively. In some examples, the first sub-field is to be applied to the first set of scheduled cells based on the first set of scheduled cells being associated with the first SCS, the first carrier type, or both. In some examples, the second sub-field is to be applied to the second set of scheduled cells based on the second set of scheduled cells being associated with the second SCS, the second carrier type, or both.

In some examples, the DCI message further schedules a third shared channel communication via a third cell associated with the first SCS, the first carrier type, or both. In some examples, the first sub-field is to be applied to the first cell and the third cell based on the first cell and the third cell being associated with the first SCS, the first carrier type, or both.

In some examples, the SCS manager 1040 is capable of, configured to, or operable to support a means for receiving an indication to switch a SCS for the third cell from the first SCS to the second SCS, where the second sub-field is to be applied to the second cell and the third cell based on the indication and based on the second cell and the third cell being associated with the second SCS.

In some examples, the indication to switch the SCS for the third cell includes a BWP switch associated with the third cell.

In some examples, the DCI message schedules a set of multiple shared channel communications for a set of multiple scheduled cells, the set of multiple scheduled cells including at least the first cell and the second cell. In some examples, a quantity of sub-fields for the cell parameter included within the DCI message is based on a quantity of unique SCSs, a quantity of unique carrier types, or both, associated with the set of multiple scheduled cells.

In some examples, the first sub-field and the second sub-field are applied to the first cell and the second cell, respectively, based on the first cell being associated with the first SCS and the second cell being associated with the second SCS.

In some examples, the RRC receiving manager 1035 is capable of, configured to, or operable to support a means for receiving RRC signaling indicating the first SCS associated with the first cell and the second SCS associated with the second cell, where communication of the first shared channel communication, the second shared channel communication, or both, is based on reception of the RRC signaling.

In some examples, the first sub-field is applied to the first cell and the second sub-field is applied to the second cell based on the first cell being associated with the first carrier type and the second cell being associated with the second carrier type.

In some examples, the first cell and the second cell are associated with a first cell ID and a second cell ID, respectively. In some examples, the first sub-field is to be applied for the first cell and the second sub-field is to be applied for the second cell based on a comparison between the first cell ID and the second cell ID.

In some examples, the first sub-field and the second sub-field include sub-fields of a Type 1A field of the DCI message.

In some examples, the DCI message includes a DCI format 0_3 or a DCI format 1_3.

In some examples, the cell parameter includes a BWP indicator, a FH flag, a DMRS sequence initialization, a priority indicator, an offset, a channel access parameter, or any combination thereof.

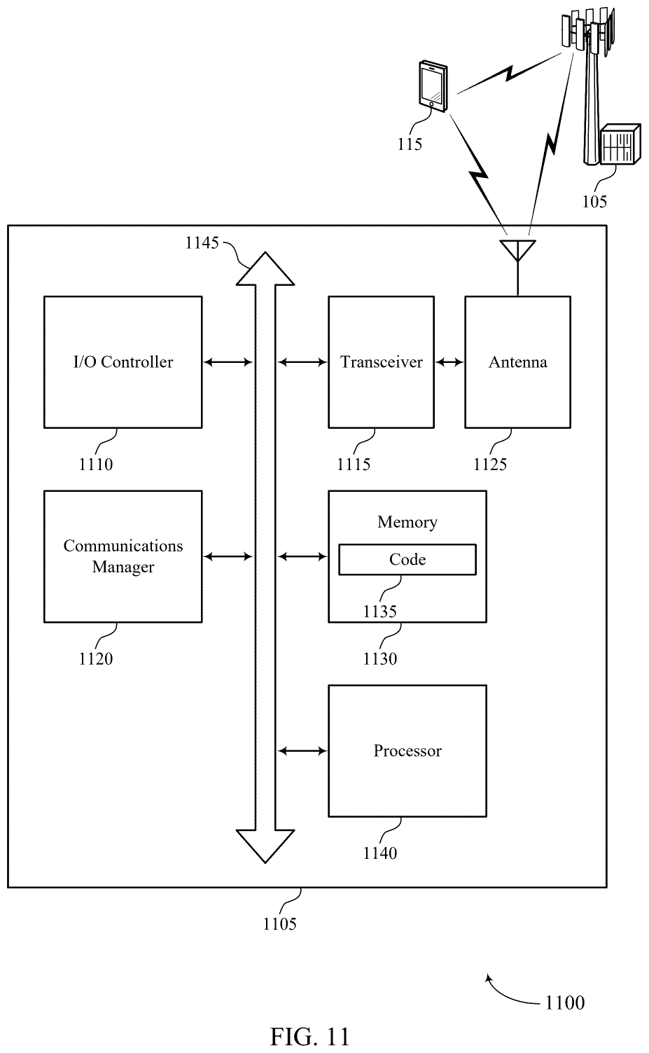

FIG. 11 shows a diagram of a system 1100 including a device 1105 that supports techniques for multi-cell scheduling with different SCSs or carrier types in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting techniques for multi-cell scheduling with different SCSs or carrier types). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

For example, the communications manager 1120 is capable of, configured to, or operable to support a means for receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell. The communications manager 1120 is capable of, configured to, or operable to support a means for communicating the first shared channel communication via the first cell in accordance with the first parameter value for the cell parameter. The communications manager 1120 is capable of, configured to, or operable to support a means for communicating the second shared channel communication via the second cell in accordance with the second parameter value for the cell parameter.

By including or configuring the communications manager 1120 in accordance with examples as described herein, the device 1105 may support techniques that facilitate improved multi-cell scheduling. In particular, aspects of the present disclosure may enable DCI messages to indicate cell parameters for scheduled cells with different SCSs and/or carrier types, thereby reducing the quantity of control signaling exchanged within the network (e.g., by preventing the network from having to send different DCI messages to schedule communications on scheduled cells with different SCSs/carrier types). Further, by reducing the amount of control signaling used to schedule communications at the UE, aspects of the present disclosure may reduce the power consumption at the UE, thereby improving battery life.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of techniques for multi-cell scheduling with different SCSs or carrier types as described herein, or the at least one processor 1140 and the at least one memory 1130 may be otherwise configured to, individually or collectively, perform or support such operations.

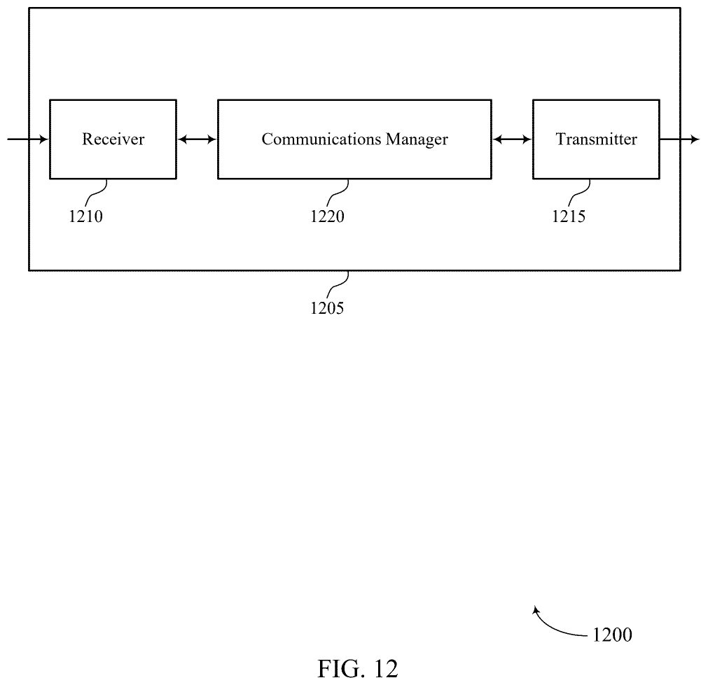

FIG. 12 shows a block diagram 1200 of a device 1205 that supports techniques for multi-cell scheduling with different SCSs or carrier types in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of techniques for multi-cell scheduling with different SCSs or carrier types as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

For example, the communications manager 1220 is capable of, configured to, or operable to support a means for outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell. The communications manager 1220 is capable of, configured to, or operable to support a means for communicating the first shared channel communication via the first cell in accordance with the first parameter value for the cell parameter. The communications manager 1220 is capable of, configured to, or operable to support a means for communicating the second shared channel communication via the second cell in accordance with the second parameter value for the cell parameter.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques that facilitate improved multi-cell scheduling. In particular, aspects of the present disclosure may enable DCI messages to indicate cell parameters for scheduled cells with different SCSs and/or carrier types, thereby reducing the quantity of control signaling exchanged within the network (e.g., by preventing the network from having to send different DCI messages to schedule communications on scheduled cells with different SCSs/carrier types). Further, by reducing the amount of control signaling used to schedule communications at the UE, aspects of the present disclosure may reduce the power consumption at the UE, thereby improving battery life.

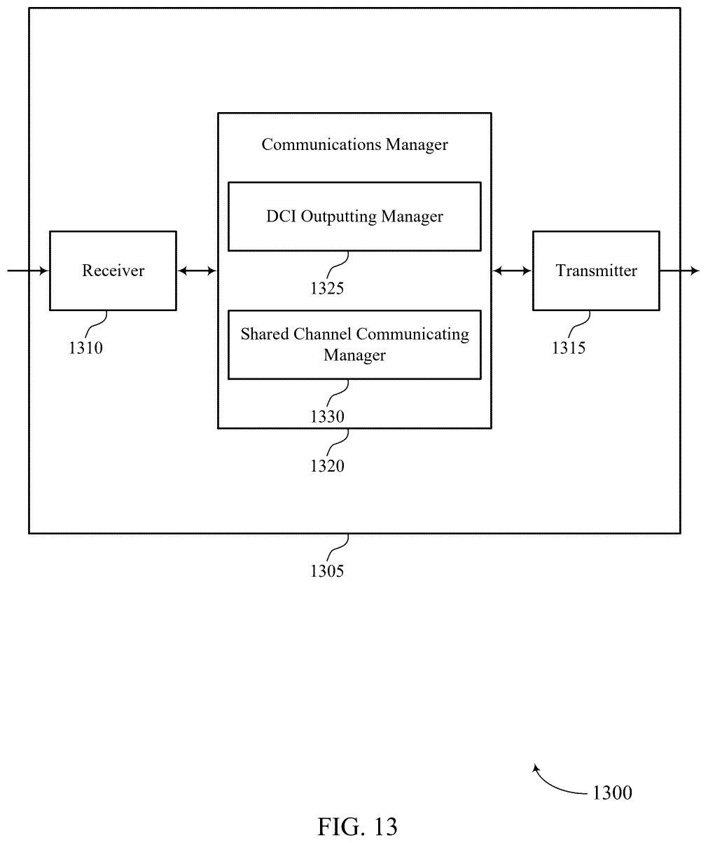

FIG. 13 shows a block diagram 1300 of a device 1305 that supports techniques for multi-cell scheduling with different SCSs or carrier types in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for multi-cell scheduling with different SCSs or carrier types as described herein. For example, the communications manager 1320 may include a DCI outputting manager 1325 a shared channel communicating manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The DCI outputting manager 1325 is capable of, configured to, or operable to support a means for outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell. The shared channel communicating manager 1330 is capable of, configured to, or operable to support a means for communicating the first shared channel communication via the first cell in accordance with the first parameter value for the cell parameter. The shared channel communicating manager 1330 is capable of, configured to, or operable to support a means for communicating the second shared channel communication via the second cell in accordance with the second parameter value for the cell parameter.

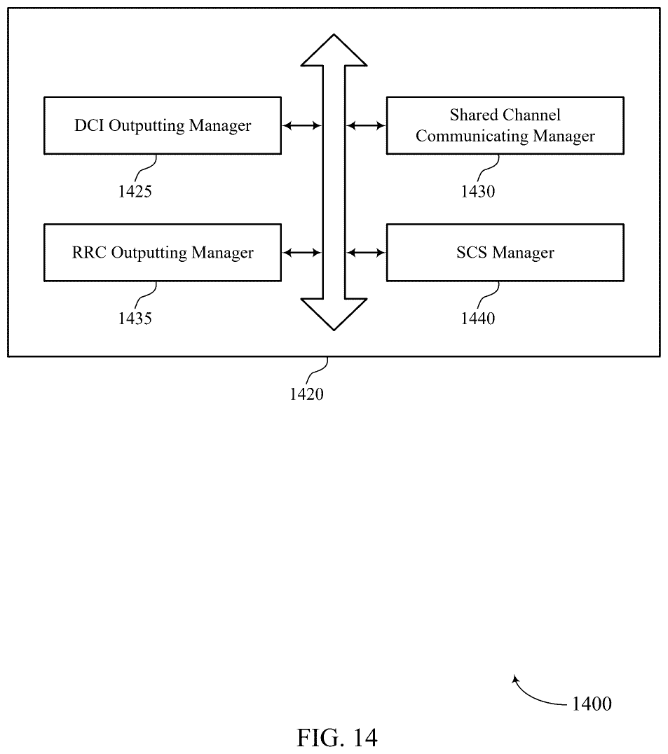

FIG. 14 shows a block diagram 1400 of a communications manager 1420 that supports techniques for multi-cell scheduling with different SCSs or carrier types in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for multi-cell scheduling with different SCSs or carrier types as described herein. For example, the communications manager 1420 may include a DCI outputting manager 1425, a shared channel communicating manager 1430, an RRC outputting manager 1435, an SCS manager 1440, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The DCI outputting manager 1425 is capable of, configured to, or operable to support a means for outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell. The shared channel communicating manager 1430 is capable of, configured to, or operable to support a means for communicating the first shared channel communication via the first cell in accordance with the first parameter value for the cell parameter. In some examples, the shared channel communicating manager 1430 is capable of, configured to, or operable to support a means for communicating the second shared channel communication via the second cell in accordance with the second parameter value for the cell parameter.

In some examples, the DCI message further schedules a third shared channel communication via a third cell associated with a third SCS, a third carrier type, or both. In some examples, the DCI message further includes a third sub-field that indicates a third parameter value for the cell parameter that is to be applied for the third cell.

In some examples, the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells including at least the first cell and the second cell, respectively. In some examples, the first sub-field is to be applied to the first set of scheduled cells based on the first set of scheduled cells being associated with the first SCS, the first carrier type, or both. In some examples, the second sub-field is to be applied to the second set of scheduled cells based on the second set of scheduled cells being associated with the second SCS, the second carrier type, or both.

In some examples, the DCI message further schedules a third shared channel communication via a third cell associated with the first SCS, the first carrier type, or both. In some examples, the first sub-field is to be applied to the first cell and the third cell based on the first cell and the third cell being associated with the first SCS, the first carrier type, or both.

In some examples, the SCS manager 1440 is capable of, configured to, or operable to support a means for outputting an indication to switch a SCS for the third cell from the first SCS to the second SCS, where the second sub-field is to be applied to the second cell and the third cell based on the indication and based on the second cell and the third cell being associated with the second SCS.

In some examples, the indication to switch the SCS for the third cell includes a BWP switch associated with the third cell.

In some examples, the DCI message schedules a set of multiple shared channel communications for a set of multiple scheduled cells, the set of multiple scheduled cells including at least the first cell and the second cell. In some examples, a quantity of sub-fields for the cell parameter included within the DCI message is based on a quantity of unique SCSs, a quantity of unique carrier types, or both, associated with the set of multiple scheduled cells.

In some examples, the first sub-field and the second sub-field are applied to the first cell and the second cell, respectively, based on the first cell being associated with the first SCS and the second cell being associated with the second SCS.

In some examples, the RRC outputting manager 1435 is capable of, configured to, or operable to support a means for outputting RRC signaling indicating the first SCS associated with the first cell and the second SCS associated with the second cell, where communication of the first shared channel communication, the second shared channel communication, or both, is based on output of the RRC signaling.

In some examples, the first sub-field is applied to the first cell and the second sub-field is applied to the second cell based on the first cell being associated with the first carrier type and the second cell being associated with the second carrier type.

In some examples, the first cell and the second cell are associated with a first cell ID and a second cell ID, respectively. In some examples, the first sub-field is to be applied for the first cell and the second sub-field is to be applied for the second cell based on a comparison between the first cell ID and the second cell ID.

In some examples, the first sub-field and the second sub-field include sub-fields of a Type 1A field of the DCI message.

In some examples, the DCI message includes a DCI format 0_3 or a DCI format 1_3.

In some examples, the cell parameter includes a BWP indicator, a FH flag, a DMRS sequence initialization, a priority indicator, an offset, a channel access parameter, or any combination thereof.

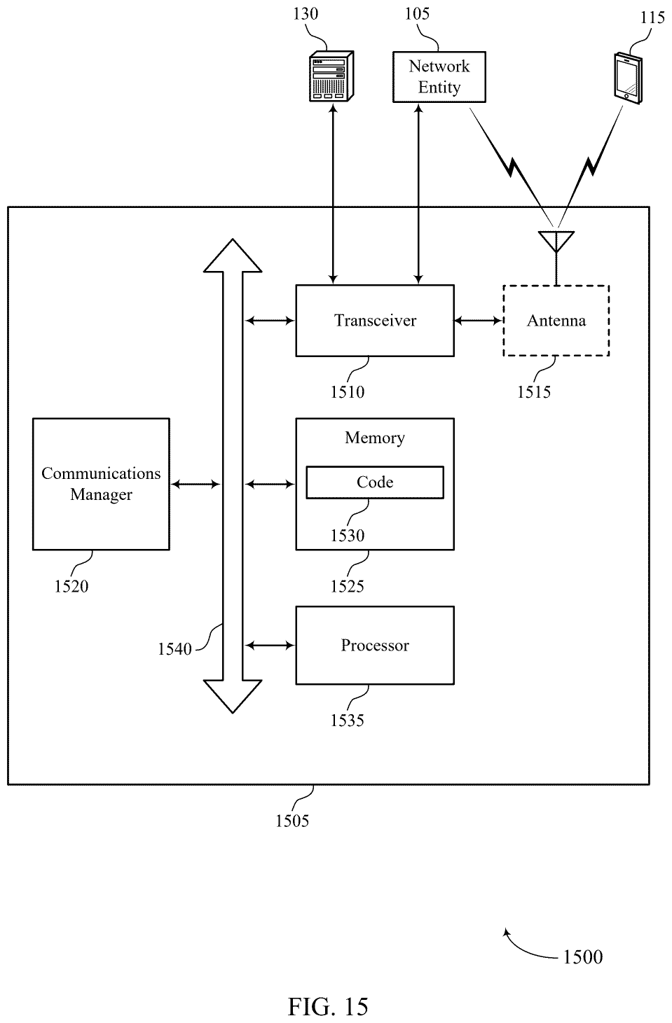

FIG. 15 shows a diagram of a system 1500 including a device 1505 that supports techniques for multi-cell scheduling with different SCSs or carrier types in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting techniques for multi-cell scheduling with different SCSs or carrier types). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

For example, the communications manager 1520 is capable of, configured to, or operable to support a means for outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell. The communications manager 1520 is capable of, configured to, or operable to support a means for communicating the first shared channel communication via the first cell in accordance with the first parameter value for the cell parameter. The communications manager 1520 is capable of, configured to, or operable to support a means for communicating the second shared channel communication via the second cell in accordance with the second parameter value for the cell parameter.

By including or configuring the communications manager 1520 in accordance with examples as described herein, the device 1505 may support techniques that facilitate improved multi-cell scheduling. In particular, aspects of the present disclosure may enable DCI messages to indicate cell parameters for scheduled cells with different SCSs and/or carrier types, thereby reducing the quantity of control signaling exchanged within the network (e.g., by preventing the network from having to send different DCI messages to schedule communications on scheduled cells with different SCSs/carrier types). Further, by reducing the amount of control signaling used to schedule communications at the UE, aspects of the present disclosure may reduce the power consumption at the UE, thereby improving battery life.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of techniques for multi-cell scheduling with different SCSs or carrier types as described herein, or the at least one processor 1535 and the at least one memory 1525 may be otherwise configured to, individually or collectively, perform or support such operations.

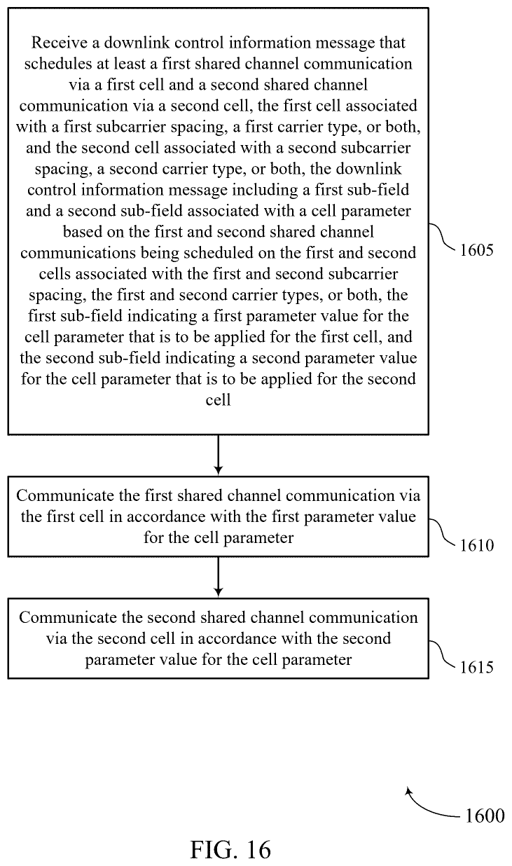

FIG. 16 shows a flowchart illustrating a method 1600 that supports techniques for multi-cell scheduling with different SCSs or carrier types in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first sub-field and a second sub-field associated with a cell parameter based on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell. The operations of 1605 may be performed in accordance with examples as disclosed herein. In some examples, aspects of the operations of 1605 may be performed by a DCI receiving manager 1025 as described with reference to FIG. 10.

At 1610, the method may include communicating the first shared channel communication via the first cell in accordance with the first parameter value for the cell parameter. The operations of 1610 may be performed in accordance with examples as disclosed herein. In some examples, aspects of the operations of 1610 may be performed by a shared channel communicating manager 1030 as described with reference to FIG. 10.

At 1615, the method may include communicating the second shared channel communication via the second cell in accordance with the second parameter value for the cell parameter. The operations of 1615 may be performed in accordance with examples as disclosed herein. In some examples, aspects of the operations of 1615 may be performed by a shared channel communicating manager 1030 as described with reference to FIG. 10.

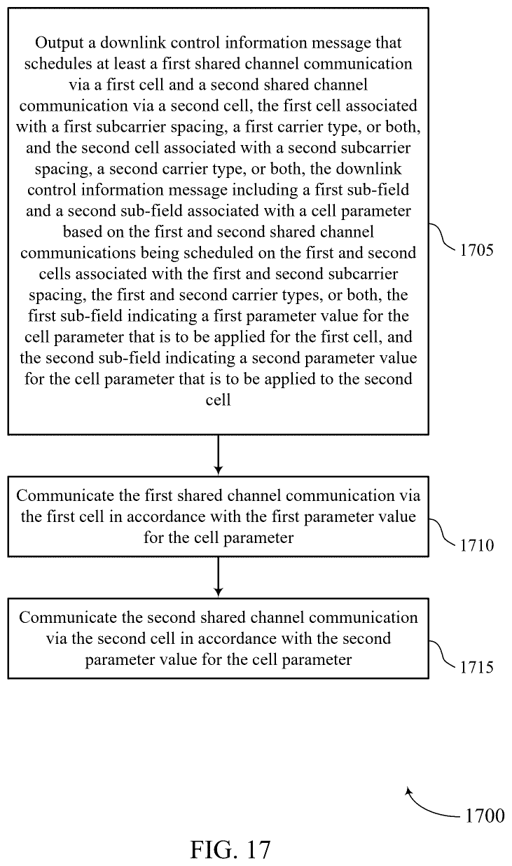

FIG. 17 shows a flowchart illustrating a method 1700 that supports techniques for multi-cell scheduling with different SCSs or carrier types in accordance with one or more aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits and a second subset of bits associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied to the second cell. The operations of 1705 may be performed in accordance with examples as disclosed herein. In some examples, aspects of the operations of 1705 may be performed by a DCI outputting manager 1425 as described with reference to FIG. 14.

At 1710, the method may include communicating the first shared channel communication via the first cell in accordance with the first parameter value for the cell parameter. The operations of 1710 may be performed in accordance with examples as disclosed herein. In some examples, aspects of the operations of 1710 may be performed by a shared channel communicating manager 1430 as described with reference to FIG. 14.

At 1715, the method may include communicating the second shared channel communication via the second cell in accordance with the second parameter value for the cell parameter. The operations of 1715 may be performed in accordance with examples as disclosed herein. In some examples, aspects of the operations of 1715 may be performed by a shared channel communicating manager 1430 as described with reference to FIG. 14.

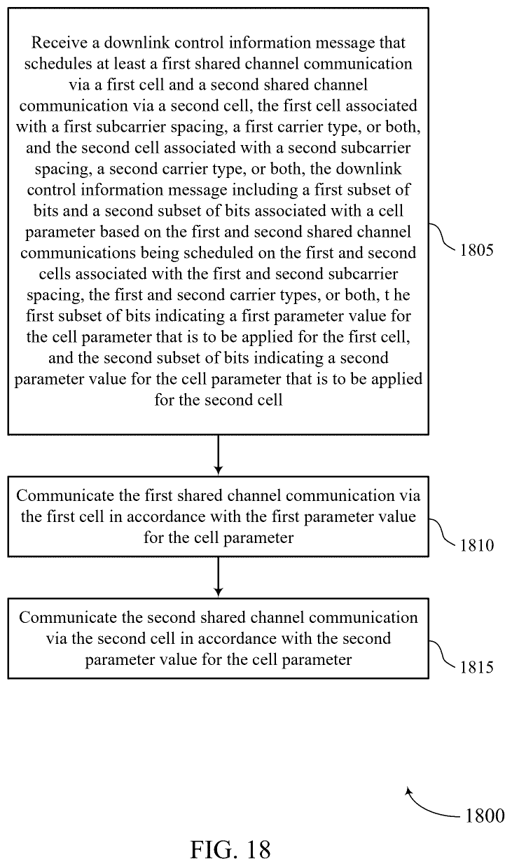

FIG. 18 shows a flowchart illustrating a method 1800 that supports techniques for multi-cell scheduling with different SCSs or carrier types in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 8105, the method may include receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits and a second subset of bits associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied for the second cell. The operations of 1805 may be performed in accordance with examples as disclosed herein. In some examples, aspects of the operations of 1805 may be performed by a DCI receiving manager 1025 as described with reference to FIG. 10.

At 1810, the method may include communicating the first shared channel communication via the first cell in accordance with the first parameter value for the cell parameter. The operations of 1810 may be performed in accordance with examples as disclosed herein. In some examples, aspects of the operations of 1810 may be performed by a shared channel communicating manager 1030 as described with reference to FIG. 10.

At 1815, the method may include communicating the second shared channel communication via the second cell in accordance with the second parameter value for the cell parameter. The operations of 1815 may be performed in accordance with examples as disclosed herein. In some examples, aspects of the operations of 1815 may be performed by a shared channel communicating manager 1030 as described with reference to FIG. 10.

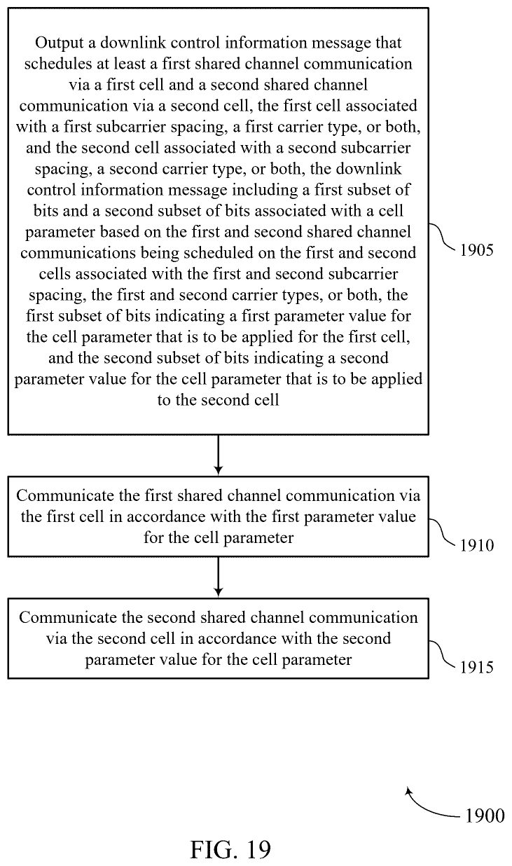

FIG. 19 shows a flowchart illustrating a method 1900 that supports techniques for multi-cell scheduling with different SCSs or carrier types in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message including a first subset of bits and a second subset of bits associated with a cell parameter based on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied to the second cell. The operations of 1905 may be performed in accordance with examples as disclosed herein. In some examples, aspects of the operations of 1905 may be performed by a DCI outputting manager 1425 as described with reference to FIG. 14.

At 1910, the method may include communicating the first shared channel communication via the first cell in accordance with the first parameter value for the cell parameter. The operations of 1910 may be performed in accordance with examples as disclosed herein. In some examples, aspects of the operations of 1910 may be performed by a shared channel communicating manager 1430 as described with reference to FIG. 14.

At 1915, the method may include communicating the second shared channel communication via the second cell in accordance with the second parameter value for the cell parameter. The operations of 1915 may be performed in accordance with examples as disclosed herein. In some examples, aspects of the operations of 1915 may be performed by a shared channel communicating manager 1430 as described with reference to FIG. 14.

The following provides an overview of aspects of the present disclosure:
Aspect 1: A method for wireless communications at a UE, comprising: receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message comprising a first subset of bits and a second subset of bits associated with a cell parameter based at least in part on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied for the second cell; communicating the first shared channel communication via the first cell in accordance with the first parameter value for the cell parameter; and communicating the second shared channel communication via the second cell in accordance with the second parameter value for the cell parameter.
Aspect 2: The method of aspect 35, wherein the DCI message further schedules a third shared channel communication via a third cell associated with a third SCS, a third carrier type, or both, the DCI message further comprises a third subset of bits that indicates a third parameter value for the cell parameter that is to be applied for the third cell.
Aspect 3: The method of any of aspects 35 through 36, wherein the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells comprising at least the first cell and the second cell, respectively, the first subset of bits is to be applied to the first set of scheduled cells based at least in part on the first set of scheduled cells being associated with the first SCS, the first carrier type, or both, and the second subset of bits is to be applied to the second set of scheduled cells based at least in part on the second set of scheduled cells being associated with the second SCS, the second carrier type, or both.
Aspect 4: The method of any of aspects 35 through 37, wherein the DCI message further schedules a third shared channel communication via a third cell associated with the first SCS, the first carrier type, or both, the first subset of bits is to be applied to the first cell and the third cell based at least in part on the first cell and the third cell being associated with the first SCS, the first carrier type, or both.
Aspect 5: The method of aspect 38, further comprising: receiving an indication to switch an SCS for the third cell from the first SCS to the second SCS, wherein the second subset of bits is to be applied to the second cell and the third cell based at least in part on the indication and based at least in part on the second cell and the third cell being associated with the second SCS.
Aspect 6: The method of aspect 39, wherein the indication to switch the SCS for the third cell comprises a BWP switch associated with the third cell.
Aspect 7: The method of any of aspects 35 through 40, wherein the DCI message schedules a plurality of shared channel communications for a plurality of scheduled cells, the plurality of scheduled cells comprising at least the first cell and the second cell, a quantity of subsets of bits for the cell parameter included within the DCI message is based at least in part on a quantity of unique SCSs, a quantity of unique carrier types, or both, associated with the plurality of scheduled cells.
Aspect 8: The method of any of aspects 35 through 41, wherein the first subset of bits and the second subset of bits are applied to the first cell and the second cell, respectively, based at least in part on the first cell and the second cell being associated with the first SCS and the second SCS, respectively.
Aspect 9: The method of any of aspects 35 through 42, further comprising: receiving RRC signaling indicating the first SCS and the second SCS associated with the first cell and the second cell, respectively, wherein communication of the first shared channel communication, the second shared channel communication, or both, is based at least in part on reception of the RRC signaling.
Aspect 10: The method of any of aspects 35 through 43, wherein the first subset of bits is applied to the first cell and the second subset of bits is applied to the second cell based at least in part on the first cell being associated with the first carrier type and the second cell being associated with the second carrier type.
Aspect 11: The method of any of aspects 35 through 44, wherein the first cell and the second cell are associated with a first cell ID and a second cell ID, respectively, the first subset of bits and the second subset of bits are to be applied for the first cell and the second cell, respectively, based at least in part on a comparison between the first cell ID and the second cell ID.
Aspect 12: The method of any of aspects 35 through 45, wherein the first subset of bits and the second subset of bits comprise subsets of bits of a Type 1A field of the DCI message.
Aspect 13: The method of any of aspects 35 through 46, wherein the DCI message comprises a DCI format 0_3 or a DCI format 1_3.
Aspect 14: The method of any of aspects 35 through 47, wherein the cell parameter comprises a BWP indicator, a frequency hopping flag, a DMRS initialization, a priority indicator, an offset, a channel access parameter, or any combination thereof.
Aspect 15: A method for wireless communications at a network entity, comprising: outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message comprising a first subset of bits and a second subset of bits associated with a cell parameter based at least in part on the first and second shared channel communications being scheduled on the first and second cells associated with the first and second SCS, the first and second carrier types, or both, the first subset of bits indicating a first parameter value for the cell parameter that is to be applied for the first cell, and the second subset of bits indicating a second parameter value for the cell parameter that is to be applied to the second cell; communicating the first shared channel communication via the first cell in accordance with the first parameter value for the cell parameter; and communicating the second shared channel communication via the second cell in accordance with the second parameter value for the cell parameter.
Aspect 16: The method of aspect 49, wherein the DCI message further schedules a third shared channel communication via a third cell associated with a third SCS, a third carrier type, or both, the DCI message further comprises a third subset of bits that indicates a third parameter value for the cell parameter that is to be applied for the third cell.
Aspect 17: The method of any of aspects 49 through 50, wherein the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells comprising at least the first cell and the second cell, respectively, the first subset of bits is to be applied to the first set of scheduled cells based at least in part on the first set of scheduled cells being associated with the first SCS, the first carrier type, or both, and the second subset of bits is to be applied to the second set of scheduled cells based at least in part on the second set of scheduled cells being associated with the second SCS, the second carrier type, or both.
Aspect 18: The method of any of aspects 49 through 51, wherein the DCI message further schedules a third shared channel communication via a third cell associated with the first SCS, the first carrier type, or both, the first subset of bits is to be applied to the first cell and the third cell based at least in part on the first cell and the third cell being associated with the first SCS, the first carrier type, or both.
Aspect 19: The method of aspect 52, further comprising: outputting an indication to switch an SCS for the third cell from the first SCS to the second SCS, wherein the second subset of bits is to be applied to the second cell and the third cell based at least in part on the indication and based at least in part on the second cell and the third cell being associated with the second SCS.
Aspect 20: The method of aspect 53, wherein the indication to switch the SCS for the third cell comprises a BWP switch associated with the third cell.
Aspect 21: The method of any of aspects 49 through 54, wherein the DCI message schedules a plurality of shared channel communications for a plurality of scheduled cells, the plurality of scheduled cells comprising at least the first cell and the second cell, a quantity of subsets of bits for the cell parameter included within the DCI message is based at least in part on a quantity of unique SCSs, a quantity of unique carrier types, or both, associated with the plurality of scheduled cells.
Aspect 22: The method of any of aspects 49 through 55, wherein the first subset of bits and the second subset of bits are applied to the first cell and the second cell, respectively, based at least in part on the first cell and the second cell being associated with the first SCS and the second SCS, respectively.
Aspect 23: The method of any of aspects 49 through 56, further comprising: outputting RRC signaling indicating the first SCS and the second SCS associated with the first cell and the second cell, respectively, wherein communication of the first shared channel communication, the second shared channel communication, or both, is based at least in part on output of the RRC signaling.
Aspect 24: The method of any of aspects 49 through 57, wherein the first subset of bits is applied to the first cell and the second subset of bits is applied to the second cell based at least in part on the first cell being associated with the first carrier type and the second cell being associated with the second carrier type.
Aspect 25: The method of any of aspects 49 through 58, wherein the first cell and the second cell are associated with a first cell ID and a second cell ID, respectively, the first subset of bits and the second subset of bits are to be applied for the first cell and the second cell, respectively, based at least in part on a comparison between the first cell ID and the second cell ID.
Aspect 26: The method of any of aspects 49 through 59, wherein the first subset of bits and the second subset of bits comprise subsets of bits of a Type 1A field of the DCI message.
Aspect 27: The method of any of aspects 49 through 60, wherein the DCI message comprises a DCI format 0_3 or a DCI format 1_3.
Aspect 28: The method of any of aspects 49 through 61, wherein the cell parameter comprises a BWP indicator, a frequency hopping flag, a DMRS initialization, a priority indicator, an offset, a channel access parameter, or any combination thereof.
Aspect 29: A UE comprising one or more memories, and one or more processors coupled with the one or more memories and configured to cause the UE to perform a method of any of aspects 35 through 48.
Aspect 30: A UE comprising at least one means for performing a method of any of aspects 35 through 48.
Aspect 31: A non-transitory computer-readable medium storing code the code comprising instructions executable by one or more processors to perform a method of any of aspects 35 through 48.
Aspect 32: A network entity comprising one or more memories, and one or more processors coupled with the one or more memories and configured to cause the network entity to perform a method of any of aspects 49 through 62.
Aspect 33: A network entity comprising at least one means for performing a method of any of aspects 49 through 62.
Aspect 34: A non-transitory computer-readable medium storing code the code comprising instructions executable by one or more processors to perform a method of any of aspects 49 through 62.
Aspect 35: A method for wireless communications at a UE, comprising: receiving a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message comprising a first sub-field and a second sub-field associated with a cell parameter based at least in part on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied for the second cell; communicating the first shared channel communication via the first cell in accordance with the first parameter value for the cell parameter; and communicating the second shared channel communication via the second cell in accordance with the second parameter value for the cell parameter.
Aspect 36: The method of aspect 35, wherein the DCI message further schedules a third shared channel communication via a third cell associated with a third SCS, a third carrier type, or both, the DCI message further comprises a third sub-field that indicates a third parameter value for the cell parameter that is to be applied for the third cell.
Aspect 37: The method of any of aspects 35 through 36, wherein the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells comprising at least the first cell and the second cell, respectively, the first sub-field is to be applied to the first set of scheduled cells based at least in part on the first set of scheduled cells being associated with the first SCS, the first carrier type, or both, and the second sub-field is to be applied to the second set of scheduled cells based at least in part on the second set of scheduled cells being associated with the second SCS, the second carrier type, or both.
Aspect 38: The method of any of aspects 35 through 37, wherein the DCI message further schedules a third shared channel communication via a third cell associated with the first SCS, the first carrier type, or both, the first sub-field is to be applied to the first cell and the third cell based at least in part on the first cell and the third cell being associated with the first SCS, the first carrier type, or both.
Aspect 39: The method of aspect 38, further comprising: receiving an indication to switch an SCS for the third cell from the first SCS to the second SCS, wherein the second sub-field is to be applied to the second cell and the third cell based at least in part on the indication and based at least in part on the second cell and the third cell being associated with the second SCS.
Aspect 40: The method of aspect 39, wherein the indication to switch the SCS for the third cell comprises a BWP switch associated with the third cell.
Aspect 41: The method of any of aspects 35 through 40, wherein the DCI message schedules a plurality of shared channel communications for a plurality of scheduled cells, the plurality of scheduled cells comprising at least the first cell and the second cell, a quantity of sub-fields for the cell parameter included within the DCI message is based at least in part on a quantity of unique SCSs, a quantity of unique carrier types, or both, associated with the plurality of scheduled cells.
Aspect 42: The method of any of aspects 35 through 41, wherein the first sub-field and the second sub-field are applied to the first cell and the second cell, respectively, based at least in part on the first cell and the second cell being associated with the first SCS and the second SCS, respectively.
Aspect 43: The method of any of aspects 35 through 42, further comprising: receiving RRC signaling indicating the first SCS and the second SCS associated with the first cell and the second cell, respectively, wherein communication of the first shared channel communication, the second shared channel communication, or both, is based at least in part on reception of the RRC signaling.
Aspect 44: The method of any of aspects 35 through 43, wherein the first sub-field is applied to the first cell and the second sub-field is applied to the second cell based at least in part on the first cell being associated with the first carrier type and the second cell being associated with the second carrier type.
Aspect 45: The method of any of aspects 35 through 44, wherein the first cell and the second cell are associated with a first cell ID and a second cell ID, respectively, the first sub-field and the second sub-field are to be applied for the first cell and the second cell, respectively, based at least in part on a comparison between the first cell ID and the second cell ID.
Aspect 46: The method of any of aspects 35 through 45, wherein the first sub-field and the second sub-field comprise sub-fields of a Type 1A field of the DCI message.
Aspect 47: The method of any of aspects 35 through 46, wherein the DCI message comprises a DCI format 0_3 or a DCI format 1_3.
Aspect 48: The method of any of aspects 35 through 47, wherein the cell parameter comprises a BWP indicator, a frequency hopping flag, a DMRS initialization, a priority indicator, an offset, a channel access parameter, or any combination thereof.
Aspect 49: A method for wireless communications at a network entity, comprising: outputting a DCI message that schedules at least a first shared channel communication via a first cell and a second shared channel communication via a second cell, the first cell associated with a first SCS, a first carrier type, or both, and the second cell associated with a second SCS, a second carrier type, or both, the DCI message comprising a first sub-field and a second sub-field associated with a cell parameter based at least in part on the first and second shared channel communications being scheduled on the first and second cells associated with the first and second SCS, the first and second carrier types, or both, the first sub-field indicating a first parameter value for the cell parameter that is to be applied for the first cell, and the second sub-field indicating a second parameter value for the cell parameter that is to be applied to the second cell; communicating the first shared channel communication via the first cell in accordance with the first parameter value for the cell parameter; and communicating the second shared channel communication via the second cell in accordance with the second parameter value for the cell parameter.
Aspect 50: The method of aspect 49, wherein the DCI message further schedules a third shared channel communication via a third cell associated with a third SCS, a third carrier type, or both, the DCI message further comprises a third sub-field that indicates a third parameter value for the cell parameter that is to be applied for the third cell.
Aspect 51: The method of any of aspects 49 through 50, wherein the DCI message schedules a first set of shared channel communications via a first set of scheduled cells associated with the first SCS, the first carrier type, or both, and a second set of shared channel communications via a second set of scheduled cells associated with the second SCS, the second carrier type, or both, the first set of scheduled cells and the second set of scheduled cells comprising at least the first cell and the second cell, respectively, the first sub-field is to be applied to the first set of scheduled cells based at least in part on the first set of scheduled cells being associated with the first SCS, the first carrier type, or both, and the second sub-field is to be applied to the second set of scheduled cells based at least in part on the second set of scheduled cells being associated with the second SCS, the second carrier type, or both.
Aspect 52: The method of any of aspects 49 through 51, wherein the DCI message further schedules a third shared channel communication via a third cell associated with the first SCS, the first carrier type, or both, the first sub-field is to be applied to the first cell and the third cell based at least in part on the first cell and the third cell being associated with the first SCS, the first carrier type, or both.
Aspect 53: The method of aspect 52, further comprising: outputting an indication to switch an SCS for the third cell from the first SCS to the second SCS, wherein the second sub-field is to be applied to the second cell and the third cell based at least in part on the indication and based at least in part on the second cell and the third cell being associated with the second SCS.
Aspect 54: The method of aspect 53, wherein the indication to switch the SCS for the third cell comprises a BWP switch associated with the third cell.
Aspect 55: The method of any of aspects 49 through 54, wherein the DCI message schedules a plurality of shared channel communications for a plurality of scheduled cells, the plurality of scheduled cells comprising at least the first cell and the second cell, a quantity of sub-fields for the cell parameter included within the DCI message is based at least in part on a quantity of unique SCSs, a quantity of unique carrier types, or both, associated with the plurality of scheduled cells.
Aspect 56: The method of any of aspects 49 through 55, wherein the first sub-field and the second sub-field are applied to the first cell and the second cell, respectively, based at least in part on the first cell and the second cell being associated with the first SCS and the second SCS, respectively.
Aspect 57: The method of any of aspects 49 through 56, further comprising: outputting RRC signaling indicating the first SCS and the second SCS associated with the first cell and the second cell, respectively, wherein communication of the first shared channel communication, the second shared channel communication, or both, is based at least in part on output of the RRC signaling.
Aspect 58: The method of any of aspects 49 through 57, wherein the first sub-field is applied to the first cell and the second sub-field is applied to the second cell based at least in part on the first cell being associated with the first carrier type and the second cell being associated with the second carrier type.
Aspect 59: The method of any of aspects 49 through 58, wherein the first cell and the second cell are associated with a first cell ID and a second cell ID, respectively, the first sub-field and the second sub-field are to be applied for the first cell and the second cell, respectively, based at least in part on a comparison between the first cell ID and the second cell ID.
Aspect 60: The method of any of aspects 49 through 59, wherein the first sub-field and the second sub-field comprise sub-fields of a Type 1A field of the DCI message.
Aspect 61: The method of any of aspects 49 through 60, wherein the DCI message comprises a DCI format 0_3 or a DCI format 1_3.
Aspect 62: The method of any of aspects 49 through 61, wherein the cell parameter comprises a BWP indicator, a frequency hopping flag, a DMRS initialization, a priority indicator, an offset, a channel access parameter, or any combination thereof.
Aspect 63: A UE comprising one or more memories, and one or more processors coupled with the one or more memories and configured to cause the UE to perform a method of any of aspects 35 through 48.
Aspect 64: A UE comprising at least one means for performing a method of any of aspects 35 through 48.
Aspect 65: A non-transitory computer-readable medium storing code the code comprising instructions executable by one or more processors to perform a method of any of aspects 35 through 48.
Aspect 66: A network entity comprising one or more memories, and one or more processors coupled with the one or more memories and configured to cause the network entity to perform a method of any of aspects 49 through 62.
Aspect 67: A network entity comprising at least one means for performing a method of any of aspects 49 through 62.
Aspect 68: A non-transitory computer-readable medium storing code the code comprising instructions executable by one or more processors to perform a method of any of aspects 49 through 62.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive a downlink control information message that schedules at least a first shared channel communication via a first cell and a second shared channel communication via a second cell, the first cell associated with a first subcarrier spacing, a first carrier type, or both, and the second cell associated with a second subcarrier spacing, a second carrier type, or both, the downlink control information message comprising a first subset of bits and a second subset of bits associated with a cell parameter based at least in part on the first and second shared channel communications being scheduled on the first and second cells associated with the first and second subcarrier spacing, the first and second carrier types, or both, the first subset of bits indicative of a first parameter value for the cell parameter that is to be applied for the first cell, and the second subset of bits indicative of a second parameter value for the cell parameter that is to be applied for the second cell;
communicate the first shared channel communication via the first cell in accordance with the first parameter value for the cell parameter; and
communicate the second shared channel communication via the second cell in accordance with the second parameter value for the cell parameter.

2. The apparatus of claim 1, wherein the downlink control information message further schedules a third shared channel communication via a third cell associated with a third subcarrier spacing, a third carrier type, or both, wherein the downlink control information message further comprises a third subset of bits that indicates a third parameter value for the cell parameter that is to be applied for the third cell.

3. The apparatus of claim 1, wherein the downlink control information message schedules a first set of shared channel communications via a first set of scheduled cells associated with the first subcarrier spacing, the first carrier type, or both, and a second set of shared channel communications via a second set of scheduled cells associated with the second subcarrier spacing, the second carrier type, or both, the first set of scheduled cells comprising at least the first cell and the second set of scheduled cells comprising at least the second cell, wherein the first subset of bits is to be applied to the first set of scheduled cells based at least in part on the first set of scheduled cells being associated with the first subcarrier spacing, the first carrier type, or both, and wherein the second subset of bits is to be applied to the second set of scheduled cells based at least in part on the second set of scheduled cells being associated with the second subcarrier spacing, the second carrier type, or both.

4. The apparatus of claim 1, wherein the downlink control information message further schedules a third shared channel communication via a third cell associated with the first subcarrier spacing, the first carrier type, or both, wherein the first subset of bits is to be applied to the first cell and the third cell based at least in part on the first cell and the third cell being associated with the first subcarrier spacing, the first carrier type, or both.

5. The apparatus of claim 4, wherein the one or more processors are configured to cause the UE to:
receive an indication to switch a subcarrier spacing for the third cell from the first subcarrier spacing to the second subcarrier spacing, wherein the second subset of bits is to be applied to the second cell and the third cell based at least in part on the indication and based at least in part on the second cell and the third cell being associated with the second subcarrier spacing.

6. The apparatus of claim 1, wherein the downlink control information message schedules a plurality of shared channel communications for a plurality of scheduled cells, the plurality of scheduled cells comprising at least the first cell and the second cell, wherein a quantity of subsets of bits for the cell parameter included within the downlink control information message is based at least in part on a quantity of unique subcarrier spacings, a quantity of unique carrier types, or both, associated with the plurality of scheduled cells.

7. The apparatus of claim 1, wherein the first subset of bits is applied to the first cell and the second subset of bits is applied to the second cell based at least in part on the first cell being associated with the first subcarrier spacing and the second cell being associated with the second subcarrier spacing.

8. The apparatus of claim 1, wherein the one or more processors are configured to cause the UE to:
receive radio resource control signaling indicative of the first subcarrier spacing associated with the first cell and the second subcarrier spacing associated with the second cell, wherein communication of the first shared channel communication, the second shared channel communication, or both, is based at least in part on reception of the radio resource control signaling.

9. The apparatus of claim 1, wherein the first subset of bits is applied to the first cell and the second subset of bits is applied to the second cell based at least in part on the first cell being associated with the first carrier type and the second cell being associated with the second carrier type.

10. The apparatus of claim 1, wherein the first cell is associated with a first cell identifier and the second cell is associated with a second cell identifier, wherein the first subset of bits is to be applied for the first cell and the second subset of bits is to be applied for the second cell based at least in part on a comparison between the first cell identifier and the second cell identifier.

11. The apparatus of claim 1, wherein the cell parameter comprises a bandwidth part indicator, a frequency hopping flag, a demodulation reference signal sequence initialization, a priority indicator, an offset, a channel access parameter, or any combination thereof, wherein the first subset of bits and the second subset of bits comprise bits dedicated to define the bandwidth part indicator, the frequency hopping flag, the demodulation reference signal sequence initialization, the priority indicator, the offset, the channel access parameter, or any combination thereof.

12. An apparatus for wireless communication at a network entity, comprising:
one or more memories; and
one or more processors coupled with the one or more memories and configured to cause the network entity to:
output a downlink control information message that schedules at least a first shared channel communication via a first cell and a second shared channel communication via a second cell, the first cell associated with a first subcarrier spacing, a first carrier type, or both, and the second cell associated with a second subcarrier spacing, a second carrier type, or both, the downlink control information message comprising a first subset of bits and a second subset of bits associated with a cell parameter based at least in part on the first and second shared channel communications being scheduled on the first and second cells associated with the first and second subcarrier spacing, the first and second carrier types, or both, the first subset of bits indicative of a first parameter value for the cell parameter that is to be applied for the first cell, and the second subset of bits indicative of a second parameter value for the cell parameter that is to be applied to the second cell;
communicate the first shared channel communication via the first cell in accordance with the first parameter value for the cell parameter; and
communicate the second shared channel communication via the second cell in accordance with the second parameter value for the cell parameter.

13. The apparatus of claim 12, wherein the downlink control information message further schedules a third shared channel communication via a third cell associated with a third subcarrier spacing, a third carrier type, or both, wherein the downlink control information message further comprises a third subset of bits that indicates a third parameter value for the cell parameter that is to be applied for the third cell.

14. The apparatus of claim 12, wherein the downlink control information message schedules a first set of shared channel communications via a first set of scheduled cells associated with the first subcarrier spacing, the first carrier type, or both, and a second set of shared channel communications via a second set of scheduled cells associated with the second subcarrier spacing, the second carrier type, or both, the first set of scheduled cells comprising at least the first cell and the second set of scheduled cells comprising at least the second cell, wherein the first subset of bits is to be applied to the first set of scheduled cells based at least in part on the first set of scheduled cells being associated with the first subcarrier spacing, the first carrier type, or both, and wherein the second subset of bits is to be applied to the second set of scheduled cells based at least in part on the second set of scheduled cells being associated with the second subcarrier spacing, the second carrier type, or both.

15. The apparatus of claim 12, wherein the downlink control information message further schedules a third shared channel communication via a third cell associated with the first subcarrier spacing, the first carrier type, or both, and wherein the first subset of bits is to be applied to the first cell and the third cell based at least in part on the first cell and the third cell being associated with the first subcarrier spacing, the first carrier type, or both.

16. The apparatus of claim 15, wherein the one or more processors are configured to cause the network entity to:
output an indication to switch a subcarrier spacing for the third cell from the first subcarrier spacing to the second subcarrier spacing, wherein the second subset of bits is to be applied to the second cell and the third cell based at least in part on the indication and based at least in part on the second cell and the third cell being associated with the second subcarrier spacing.

17. The apparatus of claim 12,
wherein the first subset of bits and the second subset of bits are applied to the first cell and the second cell, respectively, based at least in part on the first cell being associated with the first subcarrier spacing and the second cell being associated with the second subcarrier spacing, or based at least in part on the first cell being associated with the first carrier type and the second cell being associated with the second carrier type.

18. The apparatus of claim 12, wherein the first cell and the second cell are associated with a first cell identifier and a second cell identifier, respectively, wherein the first subset of bits and the second subset of bits are to be applied for the first cell and the second cell, respectively, based at least in part on a comparison between the first cell identifier and the second cell identifier.

19. The apparatus of claim 12, wherein the cell parameter comprises a bandwidth part indicator, a frequency hopping flag, a demodulation reference signal sequence initialization, a priority indicator, an offset, a channel access parameter, or any combination thereof, wherein the first subset of bits and the second subset of bits comprise bits dedicated to define the bandwidth part indicator, the frequency hopping flag, the demodulation reference signal sequence initialization, the priority indicator, the offset, the channel access parameter, or any combination thereof.

20. A method for wireless communications at a user equipment (UE), comprising:
receiving a downlink control information message that schedules at least a first shared channel communication via a first cell and a second shared channel communication via a second cell, the first cell associated with a first subcarrier spacing, a first carrier type, or both, and the second cell associated with a second subcarrier spacing, a second carrier type, or both, the downlink control information message comprising a first subset of bits and a second subset of bits associated with a cell parameter based at least in part on the first and second shared channel communications being scheduled on the first and second cells associated with the first and second subcarrier spacing, the first and second carrier types, or both, the first subset of bits indicating a first parameter value for the cell parameter that is to be applied for the first cell, and the second subset of bits indicating a second parameter value for the cell parameter that is to be applied for the second cell;
communicating the first shared channel communication via the first cell in accordance with the first parameter value for the cell parameter; and
communicating the second shared channel communication via the second cell in accordance with the second parameter value for the cell parameter.
